(19) United States
(12) Patent Application Publication
(10) Pub. No.: US 2025/0384324 A1
(43) Pub. Date: Dec. 18, 2025

(54) QUANTUM RESERVOIR COMPUTING WITH RYDBERG ATOM ARRAYS

(71) Applicants: President and Fellows of Harvard College, Cambridge, MA (US); Quera Computing Incorporated, Boston, MA (US)

(72) Inventors: Hongye Hu, Cambridge, MA (US); Xun Gao, Somerville, MA (US); Fangli Liu, Brighton, MA (US); Shengtao Wang, Arlington, MA (US); Jonathan Wurtz, Boston, MA (US); Milan Kornjaca, Boston, MA (US)

(21) Appl. No.: 19/107,187

(22) PCT Filed: Aug. 29, 2023
(86) PCT No.: PCT/US2023/031335

§ 371 Date: Feb. 27, 2025

Related U.S. Application Data
(60) Provisional application No. 63/402,118, filed on Aug. 30, 2022.

(51) Int. Cl. G06N 10/60; G06N 10/20; G06N 10/40

(52) U.S. Cl. CPC G06N 10/60; G06N 10/20; G06N 10/40

(57) ABSTRACT

Quantum reservoir computation is provided. A first feature vector is determined from input data. A plurality of qubits is configured in an initial configuration according to the first feature vector, wherein a detuning, Rabi frequency, phase, and/or position of each of the plurality of qubits is determined by a respective one of the values of the first feature vector. The plurality of qubits is evolved for a first time. The plurality of qubits is measured to obtain first measurements after the first time. The plurality of qubits is returned to the initial configuration. The plurality of qubits is evolved for a second time. The plurality of qubits is measured to obtain second measurements after the second time. A second feature vector is determined from the first and second measurements. The second feature vector is provided to a decoder and a characteristic of the input data is obtained therefrom.

### CROSS-REFERENCE TO RELATED APPLICATIONS

This application claims the benefit of U.S. Provisional Application No. 63/402,118, filed Aug. 30, 2022, which is hereby incorporated by reference in its entirety.

### STATEMENT REGARDING FEDERALLY SPONSORED RESEARCH OR DEVELOPMENT

This invention was made with government support under W911NF1910302 and W911NF2010082 awarded by U.S. Army Research Office (ARO). The government has certain rights in this invention.

### BACKGROUND

Embodiments of the present disclosure relate to quantum computation, and more specifically, to quantum reservoir computing with Rydberg atom arrays.

### BRIEF SUMMARY

According to embodiments of the present disclosure, methods and computer program products for quantum reservoir computation are provided. A first feature vector is determined from input data, the first feature vector comprising a plurality of values. A plurality of qubits is configured in an initial configuration according to the first feature vector, wherein a detuning, Rabi frequency, phase, and/or position of each of the plurality of qubits is determined by a respective one of the values of the first feature vector. The plurality of qubits is evolved for a first time. The plurality of qubits is measured to obtain first measurements after the first time. The plurality of qubits is returned to the initial configuration. The plurality of qubits is evolved for a second time different from the first time. The plurality of qubits is measured to obtain second measurements after the second time. A second feature vector is determined from the first and second measurements. The second feature vector is provided to a decoder and a characteristic of the input data is obtained therefrom.

In various embodiments, determining the first feature vector comprises providing the input data to an autoencoder and receiving therefrom the first feature vector.

In various embodiments, determining the first feature vector comprises performing a principal component analysis.

In various embodiments, the plurality of qubits are trapped ions.

In various embodiments, the plurality of qubits are superconducting qubits.

In various embodiments, the plurality of qubits are neutral atoms. In various embodiments, each of the plurality of qubits is disposed in a corresponding optical trap.

In various embodiments, the plurality of qubits is disposed along a line.

In various embodiments, each of the plurality of qubits is disposed at the vertices of a lattice. In various embodiments, the lattice is a square lattice. In various embodiments, each of the plurality of qubits is disposed within a blockade radius of its nearest neighbors in the lattice.

In various embodiments, each of the plurality of qubits is configured to interact with at least another of the plurality of qubits during said evolution. In various embodiments, each of the plurality of qubits is configured to interact with its nearest neighbors among the plurality of qubits during said evolution.

In various embodiments, configuring the plurality of qubits in the initial configuration comprises applying a time-independent local detuning to each of the plurality of qubits proportionate to its respective one of the values of the first feature vector.

In various embodiments, configuring the plurality of qubits in the initial configuration comprises applying one of a time-dependent global detuning, a time-dependent global Rabi frequency, or a time-dependent global phase to the plurality of qubits proportionate to its respective one of the values of the first feature vector.

In various embodiments, configuring the plurality of qubits in the initial configuration comprises applying a local Rabi frequency and phase to each of the plurality of qubits, each proportionate to its respective one of the values of the first feature vector.

In various embodiments, configuring the plurality of qubits in the initial configuration comprises displacing each qubit from a lattice by an amount proportionate to its respective one of the values of the first feature vector.

In various embodiments, the first and second measurements are single-qubit Pauli observables of the plurality of qubits, and wherein the second feature vector comprises the first and second measurements. In various embodiments, determining the second feature vector comprises computing one or more correlations of the first and second measurements, and the second feature vector comprises the first and second measurements and the one or more correlations of the first and second measurements.

In various embodiments, the decoder comprises a classifier. In various embodiments, the classifier comprises a linear classifier. In various embodiments, the classifier is trained based on the classification of the input data.

In various embodiments, the decoder comprises a classical neural network. In various embodiments, the classical neural network comprises a linear regression layer. In various embodiments, the linear regression layer is trained based on the prediction of the input data.

In various embodiments, the characteristic comprises a class label of the input data. In various embodiments, the characteristic comprises an outcome variable of the input data.

In various embodiments, the input data comprise a time-series and the characteristic comprises a predicted future value of the time-series.

According to embodiments of the present disclosure, devices for quantum reservoir computation are provided. Such devices comprise: a plurality of optical traps, a plurality of neutral atoms, each of the plurality of neutral atoms disposed in a corresponding one of the plurality of optical traps, at least one laser: an imaging sensor, and a computing node. The computing node is configured to: determine a first feature vector from input data, the first feature vector comprising a plurality of values, cause the at least one laser to configure the plurality of neutral atoms in an initial configuration according to the first feature vector, wherein a detuning, Rabi frequency, phase, and/or position of each of the plurality of neutral atoms is determined by a respective one of the values of the first feature vector, measure the plurality of neutral atoms via the imaging sensor to obtain first measurements after a first time, cause the at least one laser to return the plurality of neutral atoms to the initial configuration, measure the plurality of neutral atoms to obtain second measurements after a second time, determine a second feature vector from the first and second measurements, and provide the second feature vector to a decoder and obtain therefrom a characteristic of the input data.

### BRIEF DESCRIPTION OF THE SEVERAL VIEWS OF THE DRAWINGS

FIG. 1 is a schematic view of an exemplary reservoir computing architecture according to embodiments of the present disclosure.

FIG. 2 is a schematic view of an exemplary Rydberg quantum reservoir computing workflow according to embodiments of the present disclosure.

FIG. 3 is a histogram showing the test error rate on a classification task using the MNIST dataset according to embodiments of the present disclosure.

FIG. 4 is a group of sample figures from the CIFAR-10 dataset.

FIG. 5 is a schematic view of an exemplary framework for contrastive unsupervised learning for raw data preprocessing according to embodiments of the present disclosure.

FIG. 6 is an exemplary attractor of Lorentz dynamics.

FIG. 7 is an exemplary simulation of fire propagation.

FIG. 8 is a graph of test accuracy according to an exemplary embodiment of the present disclosure.

FIGS. 9A-C are graphs of test accuracy according to an exemplary embodiment of the present disclosure.

FIG. 10 is a graph of test accuracy according to an exemplary embodiment of the present disclosure.

FIGS. 11A-F are graphs illustrating an exemplary embodiment of a time series prediction task.

FIGS. 12A-B are graphs of laser intensity according to an exemplary embodiment of the present disclosure.

FIG. 13 is a graph of experimental and simulated performance of a time series prediction task according to an exemplary embodiment of the present disclosure.

FIGS. 14A-E are graphs illustrating QRC embeddings for a time series prediction task according to an exemplary embodiment of the present disclosure.

FIG. 15 is a schematic view of an apparatus for quantum computation according to embodiments of the present disclosure.

FIG. 16 depicts a classical computing node according to embodiments of the present disclosure.

### DETAILED DESCRIPTION

A quantum bit (qubit) is the fundamental building block for a quantum computer. By analogy to classical bits which are used to store information in traditional computers (each bit is 0 or 1), qubits can occupy two distinct states labeled |0 [symbol] and |1 [symbol] , or any quantum superposition of the two states. In various applications, multiple qubits are entangled in order to build multi-qubit quantum gates.

Bits and qubits are each encoded in the state of real physical systems. For example, a classical bit (0 or 1) may be encoded in whether a capacitor is charged or discharged, or whether a switch is ‘on’ or ‘off’.

The term qudit (quantum digit) denotes the unit of quantum information that can be realized in suitable d-level quantum systems. A collection of qubits that can be measured to N states can implement an N-level qudit.

Quantum bits are encoded in quantum systems with two (or more) distinct quantum states. There are many physical realizations that may be employed. One example is based on individual particles such as atoms, ions, or molecules which are isolated in vacuum. These isolated atoms, ions, and molecules have many distinct quantum states that correspond to different orientations of electron spins, nuclear spins, electron orbits, and molecular rotations/vibrations.

In principle, a qubit may be encoded in any pair of quantum states of the atom/ion/molecule. In practice, a key parameter of qubits is described by their quantum coherence properties. Coherence measures the lifetime of the qubit before its information is lost. It has a close analogy with classical bits: if you prepare a classical bit in the 0 state, then after some time it may randomly be flipped to 1 due to environmental noise. Quantum mechanically, the same error may occur: |0 [symbol] may randomly flip to |1 [symbol] after some characteristic timescale. However, qubits may suffer from additional errors: for example, a superposition state (|0 [symbol] +|1 [symbol] )/√2 may randomly flip to (|0 [symbol] −|1 [symbol] )/√2. In real quantum computers, the qubits must be encoded in quantum states which have long coherence properties.

Quantum computers generally can contain many qubits, each encoded in its own atom/molecule/ion/etc. Beyond simply containing the qubits, the quantum computer should be able to (1) initialize the qubits, (2) manipulate the state of the qubits in a controlled way, and (3) read out the final states of the qubits. When it comes to manipulation of the qubits, this is usually broken down into two types: one type of qubit manipulation is a so-called single-qubit gate, which means an operation that is applied individually to a qubit. This may, for example, flip the state of the qubit from |0 [symbol] to |1 [symbol] , or it may take |0 [symbol] to a superposition state (|0 [symbol] +|1 [symbol] )/√2. The second necessary type of qubit manipulation is a multi-qubit gate, which acts collectively on two or more qubits, including those that are entangled. A multi-qubit gate is realized through some form of interaction between the qubits. The various quantum computing platforms (having various physical encodings of qubits) rely on different physical mechanisms both for single-qubit gates as well as multi-qubit gates according to the physical system that is storing the qubit.

In various embodiments of a quantum computer, a qubit is encoded in two near-ground-state energy levels of an atom, ion, or molecule. An example of this is a hyperfine qubit. Such a qubit is encoded in two electronic ground states that differ by the relative orientation of the nuclear spin with respect to the outer electron spin. Pairs of such states can be chosen so that they are particularly robust/insensitive to environmental perturbations, leading to long coherence times. These states are split in energy by the hyperfine interaction energy of the atom/ion/molecule, which is the interaction energy between the nuclear spin and the electron spin. The robustness of the qubit can be understood as the energy splitting between the two states being particularly stable. For this reason, such states are called clock states because the stable energy splitting can form an excellent frequency-reference and as such forms the basis for atomic clocks. Typical hyperfine splitting between these qubit states is in the 1-13 GHz frequency range.

To perform single-qubit gates on such a hyperfine qubit, it is possible to apply coherent microwave radiation at the exact frequency of the energy splitting between states. However, there are two drawbacks to this approach. First, microwaves cannot be applied to just one qubit without affecting adjacent qubits. This is because qubits are encoded in particles that are typically just a few microns apart from one another, and microwaves cannot be focused to such a small scale due to their large wavelength. Second, the microwave intensity is fairly limited and as such the maximum speed of single-qubit gates is correspondingly limited.

An alternative approach is based on stimulated Raman transitions. In this case, a laser field is applied to the atoms/ions/molecules. The laser field is nearly (but not exactly) resonant with an optical transition from one of the ground states to an optically excited state. The laser contains multiple frequency components separated in frequency by exactly the amount equal to the hyperfine splitting of the qubit. The atom/ion/molecule can absorb a photon from one frequency component and coherently emit into a different frequency component, and in doing so it changes its state. This approach benefits from the capability of focusing the laser field onto individual particles or subsets of particles in the quantum computer. The laser field can also be applied with high intensity, allowing much faster gate operations.

Neutral atom quantum computers encode qubits in individual neutral atoms. The neutral atoms are trapped in a vacuum chamber and levitated by trapping lasers. Most commonly, the trapping lasers are individual optical tweezers, which are individual tightly focused laser beams that trap an individual atom at the focus. Alternatively, individual atoms may be trapped in an optical lattice, which is formed from standing waves of laser light which produce a periodic structure of nodes/antinodes.

A typical approach for encoding a qubit in neutral atoms is the hyperfine qubit approach, in which two ground states split by several GHz form the qubit. Multi-qubit gates in neutral atom quantum computers are realized using a third atomic state, which is a highly-excited Rydberg state. When one atom is excited to a Rydberg state, neighboring atoms are prevented from being excited to the Rydberg state. This conditional behavior forms the basis for multi-qubit gates, such as a controlled-NOT gate. The Rydberg state is used temporarily to mediate the multi-qubit gate, and then the atoms are returned back from the Rydberg state to the ground state levels to preserve their coherence.

Trapped ion quantum computers use atomic species that are ionized, meaning they have a net charge. In most cases, many ions are trapped in one large trapping potential formed by electrodes in a vacuum chamber. The ions are pulled to the minimum of the trapping potential, but inter-ion Coulomb repulsion causes them to form a crystal structure centered in the middle of the trapping potential. Most commonly, the ions arrange into a linear chain. Other ways to trap ions are also possible, such as using optical tweezers, or trapping ions individually with local electric fields with a more complex on-chip electrode structure.

Qubits are encoded in trapped ions in multiple ways. One common approach is to use ground-state hyperfine levels, as described for neutral atoms. In trapped ions with hyperfine-qubit encoding, as with neutral atoms, single-qubit gates may use microwave radiation or stimulated Raman transitions.

Unlike in neutral atoms, trapped ion hyperfine qubits rely heavily on stimulated Raman transitions for performing multi-qubit gates. Stimulated Raman transitions may be used to control both the hyperfine state of the ion but also to change the motional state of the ion (i.e., add momentum). This can be understood as absorbing a photon moving in one direction and emitting a photon in a different direction, such that the difference in photon momentum is absorbed by the ion. Since many ions are often trapped in one collective trapping potential and are mutually repelling one another, changing the motional state of one ion affects other ions in the system, and this mechanism forms the basis for multi-qubit gates.

According to various embodiments of a quantum computer, individual particles (atoms/ions/molecules) can first be trapped in an array and arranged into particular configurations. Next, one or more particles are prepared in a desired quantum state. Quantum circuits can then be implemented by a sequence of qubit operations acting on individual qubits (single-qubit gates) or on groups of two or more qubits (multi-qubit gates). Finally, the state of the particles can be read out in order to observe the result of the quantum circuit. The readout can be accomplished using an observation system that typically includes an electron-multiplied CCD (EMCCD) camera image to detect particles' loaded positions, and a second camera image to read out the particles' final states by, for example, detecting fluorescence emitted by the particles in their final states.

With the development of near-term quantum computers, quantum machine learning has attracted attention. It is a promising application for near-term quantum computers, and has great potential for problems in computer vision, natural language processing, and modeling complicated dynamics. Similar to classical machine learning, quantum machine learning uses parameterized quantum circuits or dynamics to encode classical data. With the help of classical optimization and feedback control of the quantum computer, one can find proper parameters of the quantum computers to achieve those learning tasks.

However, there are two challenges that hinder the success of quantum machine learning on near-term quantum computers. First, without the help of quantum error correction, near-term quantum computers inevitably have noise. Noise has several effects on quantum computers: for example, it prevents one from running reliable quantum computation for a long time. For quantum machine learning, noise is more fatal. A successful quantum machine learning algorithm relies on the accurate estimation of gradients of parameters. With noise, the gradient estimation is fuzzy. Particularly when the number of qubits is large, the average of gradients of parameters is exponentially small. Therefore, the true gradient information will be disguised by the noise, and lead to defective training of a quantum learning algorithm. This phenomenon is also known as a noise-induced barren plateau.

Second, when there are many variational parameters, the feedback control time of quantum computers is significantly prolonged. In classical machine learning, with an auto-differentiation (AD) programming engine, one can calculate the gradients of many variational parameters in one run. An AD-engine enables the successful training of large classical machine learning models, such as GPT-3, which has over 150 billion variational parameters. Unlike classical machine learning, successful training with a quantum AD engine is still unclear. One needs to estimate the gradients for parameters one by one in experiments. Even though the gradient estimation time is linearly scaled with the number of variational parameters, it still prevents one from using large quantum machine learning models with many variational parameters.

To circumvent those obstacles, the present disclosure provides for quantum reservoir learning with Rydberg atom arrays. The core difference between quantum reservoir learning and other quantum machine learning models is the absence of active training for quantum variational parameters, which requires extremely long experimental time. Instead of optimizing the quantum system, all training parameters in reservoir learning are in a classical machine learning model (e.g., a linear regression layer), which can be trained on a classical computer. The quantum computer is used to represent data through the complex quantum dynamics of a quantum system.

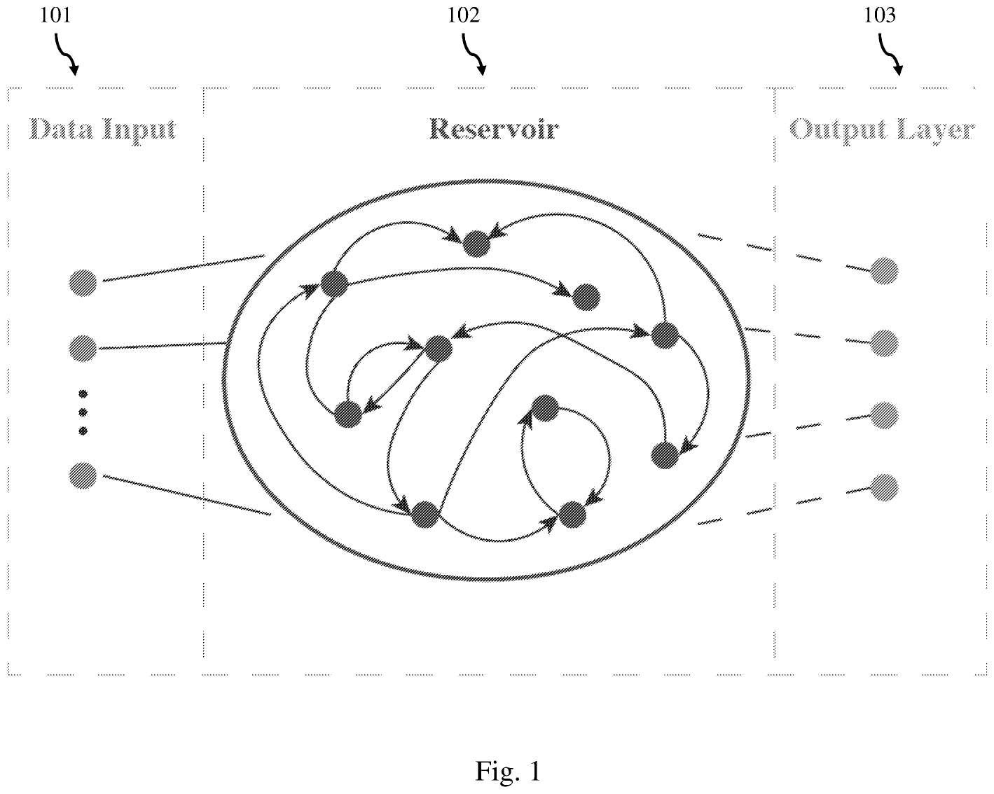

Referring to FIG. 1, an exemplary reservoir computing architecture is illustrated. Classical data are prepared in data input layer 101. In various embodiments, the classical data are formulated as an input feature vector. The feature vector may be constructed directly from simple data (e.g., coordinates), or may be extracted from source data using various feature extraction methods known in the art. For example, an autoencoder may be used to extract features from complex input data such as imagery. Additional feature extraction methods include PCA (Principal Component Analysis), LDA (Linear Discriminant Analysis), independent component analysis, isomap, kernel PCA, latent semantic analysis, partial least squares, multifactor dimensionality reduction, nonlinear dimensionality reduction, and semidefinite embedding.

Features from layer 101 are provided to reservoir 102 to set an initial state. As described below, in some embodiments the input features are encoded in the reservoir by varying one or more properties of an atomic qubit (e.g., one atomic qubit per element of an input feature vector).

After reservoir 102 has evolved over time, it is measured to prepare a new feature vector. As described below, in some embodiments a set of state measurements is taken of the quantum reservoir which are aggregated into a feature vector.

The output of the reservoir is provided to one or more decoders, such as one or more classifiers in output layer 103. Based on the input features, the classifier generates one or more outputs, such as one or more characteristics, e.g., the probability of membership in given classes.

In some embodiments, the decoder comprises a random decision forest, linear classifier, support vector machine (SVM), or artificial neural network (ANN). In some embodiments, the decoder is pre-trained using training data. In some embodiments training data is retrospective data. In some embodiments, the retrospective data is stored in a data store. In some embodiments, the learning system may be additionally trained through manual curation of previously generated outputs.

Suitable artificial neural networks include but are not limited to a feedforward neural network, a radial basis function network, a self-organizing map, learning vector quantization, a recurrent neural network, a Hopfield network, a Boltzmann machine, an echo state network, long short-term memory, a bi-directional recurrent neural network, a hierarchical recurrent neural network, a stochastic neural network, a modular neural network, an associative neural network, a deep neural network, a deep-belief network, a convolutional neural networks, a convolutional deep-belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The below notation is adopted in the following discussion of the theory of reservoir computing.
K: number of input units
N: number of reservoir nodes
L: number of output units
x(n): reservoir state at time n
u(n): input signal at time n
y(n): output signal at time n
W: N×N matrix, linear update matrix for reservoir nodes
Wⁱⁿ: N×K matrix for input weight
W^{out}: L×(K+N+L) matrix for output weight
W^{back}: N×L matrix for back action from current output signal to reservoir state at next time step
ƒ: element-wise nonlinear activation function
[x;y]: a vector that represents the concatenation of vector x and y.

The dynamics of reservoir nodes can in general be written as a linear-nonlinear model (Equation 1).

$$x ( n + 1 ) = f ( {W}^{i n} u ( n + 1 ) + W x ( n ) + {W}^{b a c k} y ( n ) ) \qquad Equation 1$$

The output of the reservoir is computed according to Equation 2.

$$y ( n + 1 ) = {f}^{o u t} ( {W}^{o u t} [ u ( n + 1 ) ; x ( n + 1 ) ; y ( n ) ] ) \qquad Equation 2$$

The learning of a reservoir computer corresponds to adjusting linear output weight W^{out} according to supervised data, while all other connections, such as W, are fixed. Reservoir computing has several advantages. First, it solves the gradient vanish/explosion problem in traditional recurrent neural network (RNN). Instead of unfolding the RNN and training every parameter in the recurrent kernel, it is only necessary to train the output weight. Second, reservoir computing units save energy during computation as compared to RNN approaches.

Consider the input sequences {u(n)}_{n∈j}∈U^{J}, where U is some compact topological space. Let {u}^{±∞}, {u}^{+∞}, {u}^{-∞}, {u}^{h} denote input sequences that are left-right-infinite (J= [symbol] ), right-infinite, left-infinite, and finite length of h, respectively. To simplify notation, a network update operator T is introduced, and x(n+h)=T(x(n), y(n), {u}^{h}) can be determined by iteratively applying Equation 1. For reservoir computing without output feedback action, this simplifies to x(n+h)=T(x(n), {u}^{h}).

With this in mind, the following properties of a reservoir computer can be defined.

Echo state property: Assume the reservoir has no output feedback action. A network has echo state property if the reservoir is uniquely determined by any left-infinite input sequences {u}^{-∞}. For every left infinite input sequence . . . , u(n−1), u(n), for all state sequences . . . , x(n−1), x(n) and . . . , x′(n−1), x′(n), where x(i)=T(x(i−1), u(i)), and x′(i)=T(x′(i−1), u(i)), giving x(n)=x′(n).

Uniformly state contracting: The reservoir is called uniformly state contracting if there exists a null sequence (δₕ)_{h≥0} such that for all {u}^{+∞}, x, x′∈A, for all input sequence {u}^{h}=u(n), . . . , u(n+h) it holds that d(T(x, {u}^{h}), T(x′, {u}^{h}))<δₕ, where d is Euclidean distance on [symbol] ^{N}.

It is provable that echo state property and uniformly state contracting are equivalent. A good reservoir should have the echo state property, because it is desirable for the reservoir to generate dynamics that are solely dependent on the input signal but not sensitive to whatever its initial state is.

The following discussion describes the training of a reservoir computer. Without loss of generality, ƒₒᵤₜ is taken to be the identity map. Other cases can be converted to this by applying

$${f}_{o u t}^{- 1}$$

to the supervised signal y. Consider a supervised learning task, where ({u}^{h}, {y}^{h}) is given. Since the internal connection between reservoir nodes is fixed, Equation 1 can be used to get the reservoir states x(i) at different times. Let \tilde{x}=[u; x; y], then the outputs of the reservoir are \tilde{y}=W^{out}\tilde{x}. If the loss function is chosen as mean-square-error, then Equation 3 holds, reducing to linear regression.

$$ϵ = {\sum }_{i = 1}^{n} {‖ {y}_{i} - {\tilde{y}}_{i} ‖}^{2} \qquad Equation 3$$

Suppose the output y is m-dimensional, x is a p-dimensional feature vector, and there are n data points. Data points are stacked (row vector) into an n×p matrix: X, and Y is a n×m matrix. The objective is to find a linear output weight W such that Equation 4 holds.

$${min}_{W} ϵ = \frac{1}{2} {\sum }_{i = 1}^{n} {‖ {X}_{i} W - {Y}_{i} ‖}^{2} + \frac{1}{2} λ {\sum }_{i = 1}^{m} {‖ {( {W}^{T} )}_{i} ‖}^{2} \qquad Equation 4$$

ε can then be rewritten as in Equation 5.

$$ϵ = \frac{1}{2} T r ( ( XW - Y ) {( XW - Y )}^{T} ) + \frac{λ}{2} T r ( {W}^{T} W ) \qquad Equation 5$$

Optimal W can then be found based on Equation 6 and Equation 7.

$$\frac{\partial ϵ}{\partial W} = {X}^{T} ( XW - Y ) + λ W = 0 \qquad Equation 6$$

$${W}_{o p t} = {( {X}^{T} X + λ I )}^{- 1} {X}^{T} Y \qquad Equation 7$$

If the learning problem does not involve sequential modeling, then x=ϕ(u) can be simply viewed as the feature vector of u under some feature map ϕ(·) realized by a physical reservoir. Then, it can be shown that reservoir computing is equivalent to the kernel ridge regression.

One useful matrix identity is given in Equation 8.

$${( {P}^{- 1} + {B}^{T} {R}^{- 1} B )}^{- 1} {B}^{T} {R}^{- 1} = P {{B}^{T} ( B P {B}^{T} + R )}^{- 1} \qquad Equation 8$$

Using this identity, the optimal weight Equation 7 can be rewritten as Equation 9 where

$${K}_{i j} = {x}_{i} \cdot {x}_{j}^{T} = ϕ ( {u}_{i} ) \cdot {ϕ ( {u}_{j} )}^{T}$$

is the kernel induced by reservoir mapping (using row where vector convention).

$${W}_{o p t} = {{X}^{T} ( X {X}^{T} + λ I )}^{- 1} Y = {{X}^{T} ( K + λ I )}^{- 1} Y \qquad Equation 9$$

This is a valid kernel since it is positive definite.

In the prediction phase, the kernel information in Equation 10 is needed, where κ(x_{new′}:) is a vector whose elements are the kernel distance between x_{new} with all training data xᵢ.

$${y}_{n e w} = {x}_{n e w} {{X}^{T} ( K + λ I )}^{- 1} Y = κ ( {x}_{new} , : ) {( K + λ I )}^{- 1} Y \qquad Equation 10$$

Coherent and scalable Rydberg-based quantum simulators host complex quantum many-body dynamics. The present disclosure uses the complex quantum dynamics of Rydberg atoms arrays as a generalization of the classical reservoir for machine learning tasks.

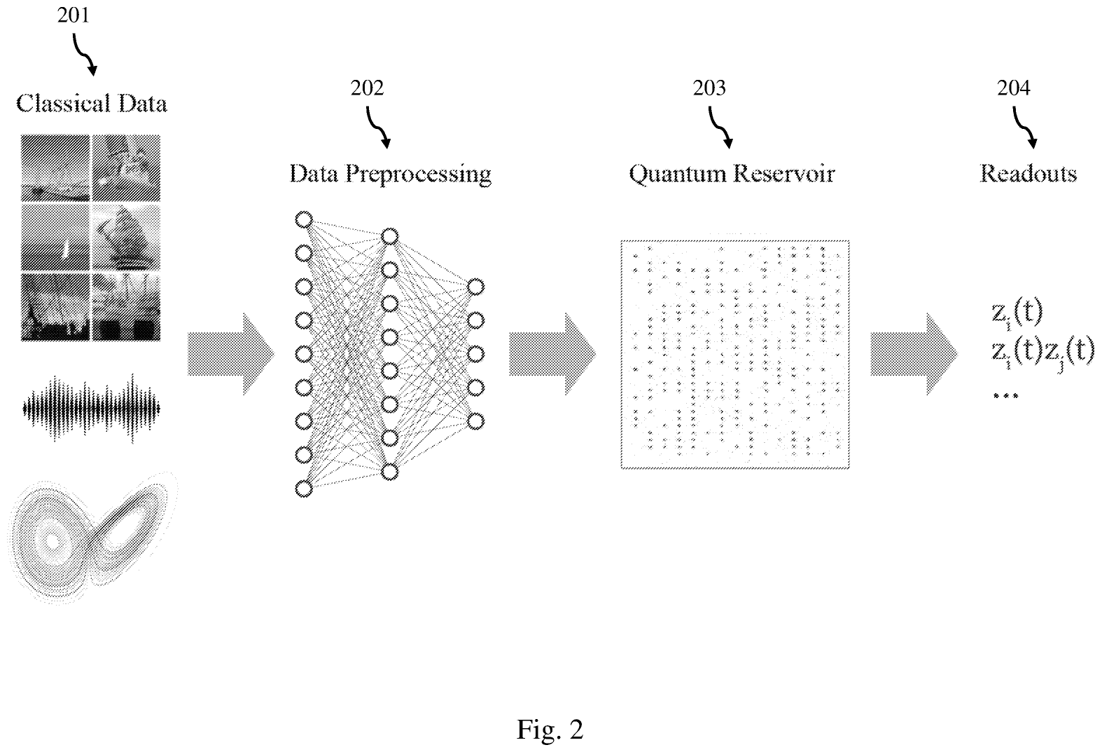

Referring to FIG. 2, a schematic of an exemplary Rydberg quantum reservoir computing workflow is provided. As in FIG. 1, classical data 201 are provided to a data preprocessing component 202 (such as an autoencoder or other feature extractor). The features obtained from data preprocessing component 202 are provided to quantum reservoir 203. After quantum reservoir 203 has evolved over time, one or more measurements 204 of the atomic qubits in the reservoir are taken.

Depending on the machine learning task, the classical raw data can be, e.g., images, audio, or trajectories of complex dynamics. In exemplary embodiments, the raw data are processed by unsupervised data processing methods, such as principal component analysis (PCA) or neural networks. In such embodiments, data preprocessing does not require any label of the data or supervision signals. The preprocessed signal is fed to the quantum reservoir.

In exemplary embodiments, the quantum reservoir consists of N Rydberg atoms. The dynamics of such a system is governed by the Hamiltonian in Equation 11, where Ω(t) is the Rabi oscillation frequency, Δ(t) is the global detuning pattern, Δ_{LD}(t) is the local detuning pattern and Vᵢⱼ=C|\vec{r}ᵢ−\vec{r}ⱼ|⁶ describes the Rydberg interaction, where C is a constant depending on the particular Rydberg state.

$$\frac{H ( t )}{ℏ} = {\sum }_{j} \frac{Ω ( t )}{2} ( {e}^{i ϕ ( t )} \vert {g}_{j} 〉 〈 {r}_{j} \vert + {e}^{- i ϕ ( t )} \vert {r}_{j} 〉 〈 {g}_{j} \vert ) - {\sum }_{j} ( Δ ( t ) + {λ}_{j} {Δ}_{L D} ( t ) ) {n}_{j} + {\sum }_{i < j} {V}_{ij} {n}_{i} {n}_{j} \qquad Equation 11$$

All available atoms or a subset thereof can be considered as the input/output (I/O) of the quantum reservoir. The preprocessed input signal u is fed to the quantum reservoir via Hamiltonian parameters (thereby establishing an initial configuration of the array). For example, in an exemplary embodiment, a detuning pattern encoding is employed, where Δ_{LD}(t) depends on u. The quantum reservoir can be prepared in some easily prepared quantum state, such as the ground state for all atoms, i.e., ρ(0)=|g [symbol] g|. In some embodiments, the initial state depends on the input signal u. Then, the one-time step update of the quantum reservoir is driven by the Rydberg Hamiltonian dynamics as shown in Equation 12.

$$ρ ( k + 1 ) = {e}^{- i H Δ t} ρ ( 0 ) {e}^{i H Δ t} \qquad Equation 12$$

After the initial state ρ(0) of the quantum reservoir is prepared, the total system is evolved under the Rydberg Hamiltonian for a time Δt. Then the I/O part of the atoms are measured. The expectation values of single qubit Pauli observables, i.e.,

$${σ}_{i}^{x} , {σ}_{i}^{y} , {σ}_{i}^{z} ,$$

higher correlations are the output of the quantum reservoir at the current time step. After the measurement, the quantum system is prepared again and evolved to a longer time step before the measurement again. After the quantum computational process, the measured value of observables is obtained at each time step. Those values together are the output of the quantum reservoir.

Based on the values output from the quantum reservoir, a classical machine learning model is trained, for example, as a classifier. In some embodiments, a one-layer classical neural network is trained, which is carried out on a classical computer. As noted above, the parameters of the complex quantum system are determined by the input classical signal. This determination does not involve any feedback training, which differs from traditional quantum machine learning models.

Quantum reservoir computation as set out herein has several practical advantages compared to variational quantum algorithms. First, variational quantum machine learning is strongly constrained by high fidelity control of the quantum resource, which is limited in today's quantum machines. In contrast, quantum reservoir computation does not need any fine tuning of the quantum system. Second, as the number of qubits and circuit depth increases, the variational quantum algorithm suffers from the barren plateau problem. This could make the quantum system extremely hard to train. Quantum reservoir computing only trains the output weight matrix. Third, for the variational quantum algorithm, the gradient evaluation usually requires the execution of the quantum circuit, which can entail a huge amount of quantum computational time. In contrast, the quantum reservoir computing does not require this, thus offering energy savings.

Numerical results (on small systems up to 16 qubits) have been carried out. These demonstrate that Rydberg atom based reservoir computing can classify hand-written digits data (MNIST) with high accuracy. The performance is better than a classical feedforward neural network with more than 250,000 training parameters.

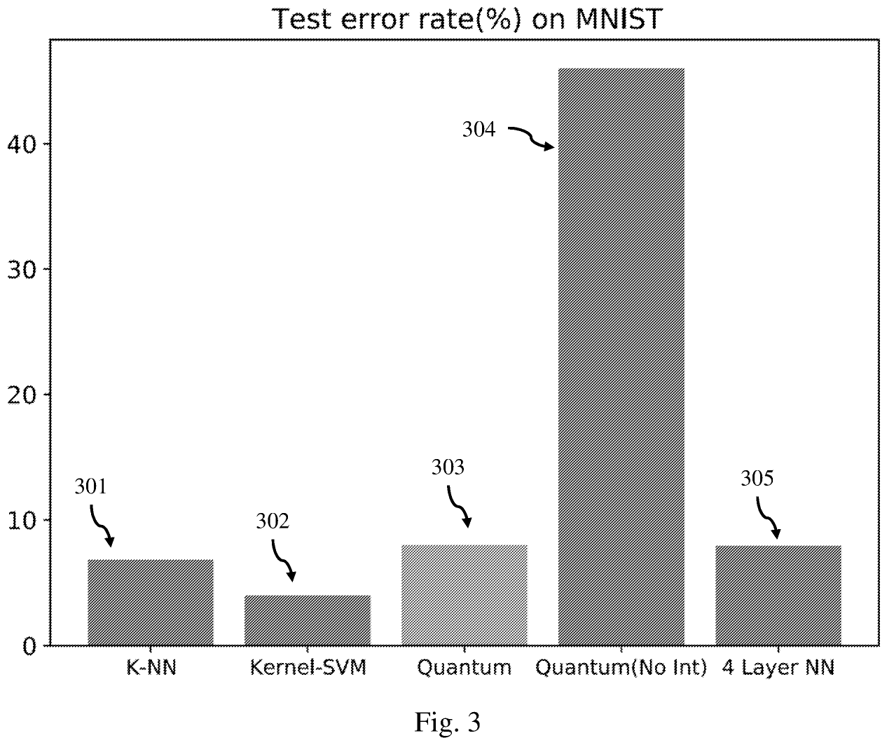

Referring to FIG. 3, a histogram is provided showing the test error rate on the MNIST dataset and various exemplary classifiers. Training was performed with 10,000 images, and testing was performed with 1,000 images. K-NN (301) corresponds to a 10 nearest neighbor classification. Kernel-SVM (302) corresponds to a Gaussian kernel support vector machine. Quantum (303) corresponds to a quantum reservoir with one dimensional Rydberg atom arrays. Quantum (No Int) (304) corresponds to a Quantum reservoir without intra-interaction. 4 Layer NN (305) corresponds to a feedforward neural network with two hidden layers containing 512 hidden neurons.

As shown, quantum reservoir learning with a one-dimensional Rydberg atom array has achieved competitive performance on the hand-digits recognition task. This approach may also be applied to object detection on real-world images.

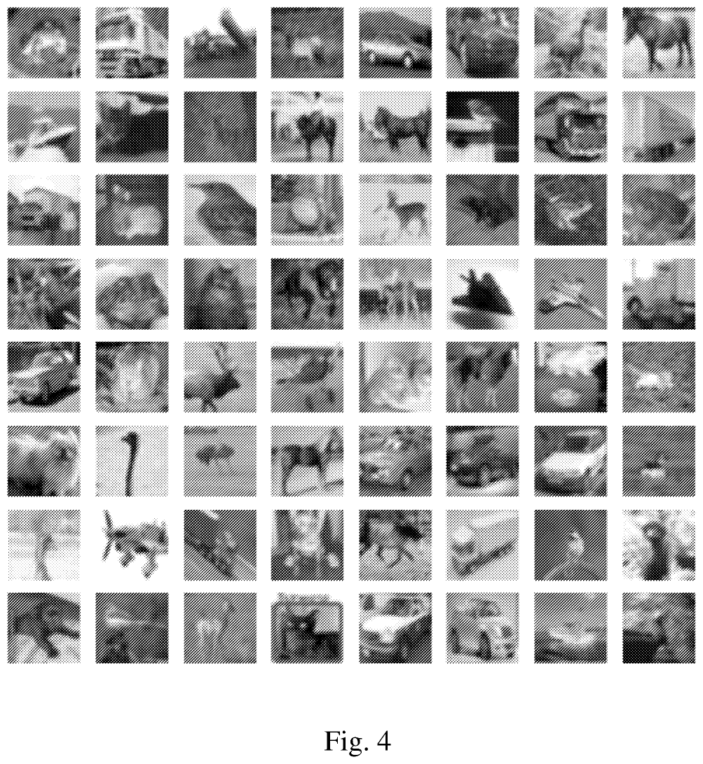

One example of such an image recognition embodiment utilizes the CIFAR-10 image dataset, which contains ten macro categories of objects, such as birds, dogs, and automobiles. In each macro category, there are subtypes. For example, in the automobile class, it contains cars, trucks and other type of vehicles. Samples from the CIFAR-10 dataset are shown in FIG. 4. As per the framework discussed with regard to FIGS. 1-2, classical data such as these images are first preprocessed in order to generate features to provide to the quantum reservoir.

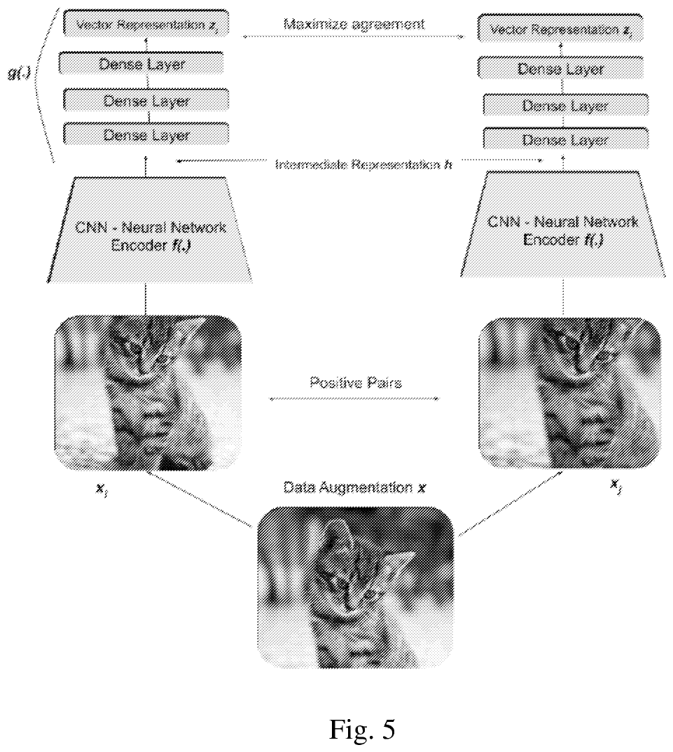

Referring to FIG. 5, an exemplary framework of contrastive unsupervised learning for raw data preprocessing is illustrated. Since each image in the CIFAR-10 dataset is large and contains RGB color channels, unsupervised machine learning techniques are employed to preprocess and downsample the raw image data. More specifically, contrastive learning is employed. A classical neural network is trained to find representation vectors for each image in the dataset in fully unsupervised fashion. The loss function of the contrastive learning can be understood as making representational vectors similar for similar images, and far away for distinct images. Similar images are generated with data augmentation for one image, as shown in FIG. 5. All other images, even within the same category, are treated as distinct images. With this method, each image is downsampled to a 15-dimensional representation vector. A linear classifier applied to these small representation vectors can achieve 83% accuracy for object classification. Accordingly, these vectors are suitable for use as input to the quantum reservoir for image learning tasks.

It will be appreciated that similar techniques may be employed to derive a feature vector from additional data types, including audio data.

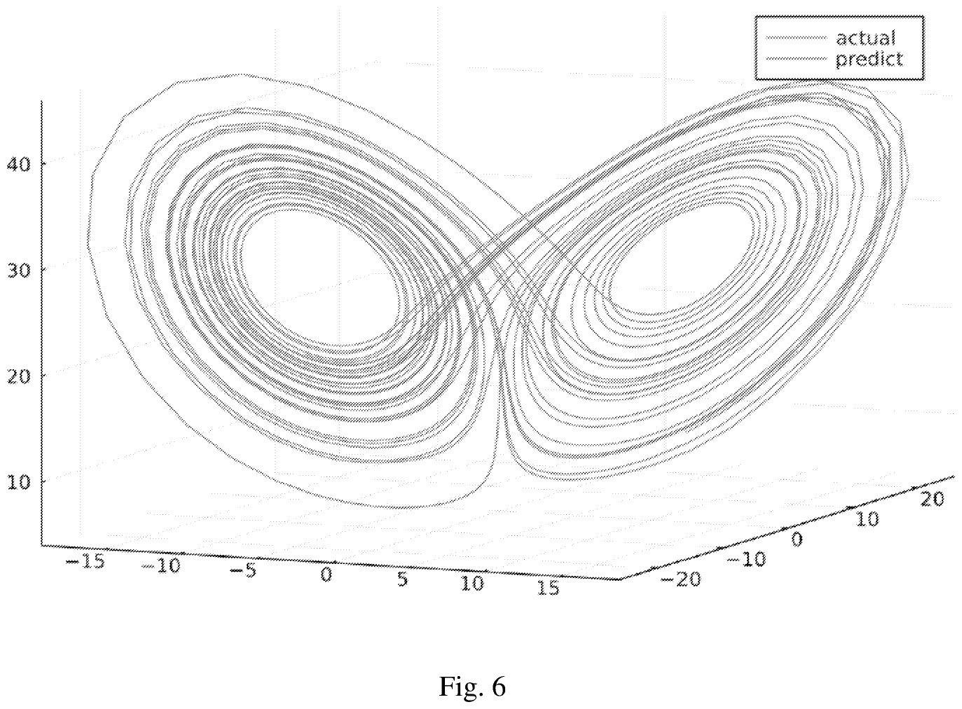

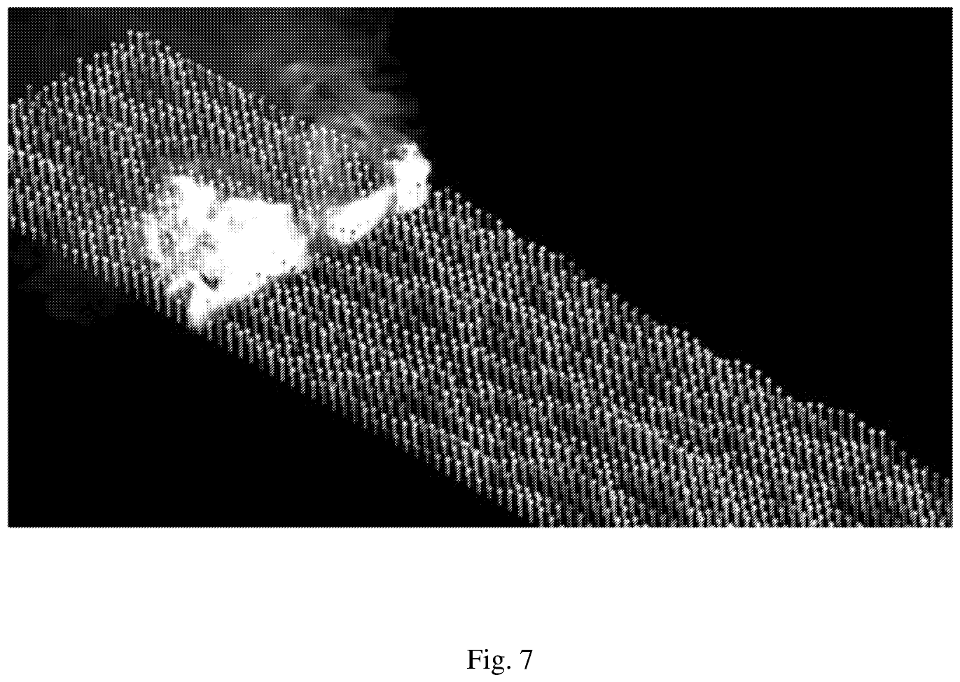

In addition to the above uses, the present disclosure is also applicable to dynamical prediction. Predicting chaotic dynamics and simulating a chaotic trajectory is important for many applications. Quantum reservoir computing can also be applied to learn such complex dynamics. Even if a chaotic system is impossible to predict accurately, it does not rule out the possibility of learning its attractors, such as the attractor shown in FIG. 6 for Lorentz equations. In data-driven simulation, quantum reservoir learning also offers possibilities in learning and simulating dynamics from observed data. For example, as shown in FIG. 7, a fire propagation simulation may be performed with reservoir computers. As compared to alternative reservoirs, the present disclosure offers an energy saving learning scheme for learning complex dynamics.

In various embodiments, input data are encoded in the local detuning patterns of all of the Rydberg atoms in an array, rather than merely a subset. The local detuning patterns may be time dependent or independent. On the output of the quantum reservoir, some embodiments measure both the local Rydberg state density and also their higher level correlations at different times. This enriched output of the quantum reservoir enables higher quality results for complicated learning tasks, such as natural images classification. Relying on measurement of local observables, such as local Rydberg density at a fixed time, loses significant dynamical information of the quantum reservoir and thus limits the quality of such alternative implementations.

In various examples above, classical data is input to the quantum Rydberg system using a detuning pattern Δᵢ(t) encoding. In additional embodiments, other encoding schemes may be employed. These include Rabi frequency encoding and atom position encoding. These encoding schemes can be applied to both time-independent signals, where Δᵢ(t) are constant, and time-dependent signals.

Similar to local detuning of an atom, each atom is also subjected to a local Rabi frequency Ωᵢ(t) and phase term ϕᵢ(t). Those 2N parameters for an N-atom array can also serve as the mapping of input data. In an exemplary Rabi frequency and phase encoding, the classical inputs (images, audio, etc.) are downsampled to a vector containing 2N elements. The first N elements are rescaled to a range [−6 MHz, 6 MHz], and each rescaled element will be the Rabi frequency of one atom in the array. The second N elements are rescaled to a range [−π,π], and serve as the phase term ϕᵢ(t) for each atom. This encoding scheme can be applied to both time independent signals, where Ωᵢ(t) and ϕᵢ(t) are constant, and time dependent signals.

In addition, atom position may be used to encode data. For example, atoms may be placed on a regular lattice (e.g., a square lattice), and then each atom is offset by amounts (Δx(t), Δy(t)) that encode the classical input data. When using this encoding scheme, the distance of two nearest neighbor atoms having the largest offset is still larger than approximately two thirds of the Rydberg blockade radius. Otherwise, the blockade effect may affect the dynamics dramatically.

The detuning pattern Δᵢ(t), Rabi pattern Ωᵢ(t), and phase pattern ϕᵢ(t) encoding scheme can also be applied to other quantum platforms, including trapped-ion and superconducting-qubit quantum devices. In particular, for a trapped-ion system, the Hamiltonian can be written as

$$H = - {\sum }_{i < j}^{L} {J}_{i , j} {σ}_{i}^{x} {σ}_{j}^{x} - {\sum }_{i}^{L} {B}_{i} ( t ) {σ}_{i}^{z} ,$$

and the classical data can be encoded in Bᵢ(t). In a trapped ion system, Bᵢ(t) plays the same role as the local detuning pattern in Rydberg atom systems.

As discussed above, in various neutral atom embodiments, obtaining output from the quantum reservoir entails measuring [symbol] zᵢ(tₖ) [symbol] and higher correlations [symbol] zᵢ (tₖ)zⱼ(tₖ) . . . [symbol] . This decoding scheme can also be applied to other quantum devices, such as superconducting-qubit based quantum circuits, and trapped-ion quantum devices, where z basis measurement is applicable.

### Results and Hardware Demonstration

The following discussion presents detailed QRC results on several real-world datasets, showing its relevance in the wide class of problems. A hardware demonstration of the algorithm is also provided.

The performance of the QRC algorithm was simulated on various image classification tasks, both extending the original proof-of-principle analysis and exploring datasets of different hardness.

The local detuning encoding, through Δᵢ(t) pattern that carries the features of the data, was already described above in connection with the MNIST dataset. Here, the parameter choices and performance of the algorithm is described in more detail, as a function of increasing encoding dimension. The choice of Hamiltonian parameters is guided by physical considerations. In particular, a strongly entangling Hamiltonian is chosen, albeit outside of the blockade regime where dynamical constraints would emerge, effectively lowering the Hilbert space dimension. This is achieved by picking hardware-relevant parameter regimes where all terms in the Hamiltonian are of comparable size, including the strength of the encoding interaction. In practice, Ω(t)=1 rad/μs, Δ(t)=0.95 rad/μs, with atoms positioned in a linear chain with distance d=10 μm, leading to nearest neighbor interaction strength of 0.86 rad/μs, while the PCA data is normalized encoded in a constant local detuning in the range of [−0.95, 0.95] rad/μs (further referred as the standard parameter set). The total evolution time is set as 4 μs, and the quantum reservoir is probed at 0.5 μs intervals, a rate that has a physical meaning of the half of the Rabi period (set by Ω). Most importantly, the physically guided choice of the QRC hyperparameters and sampling frequency eliminates the need for fine-tuning through hyperparameter optimization, as a similar level of performance is observed in a wide region of parameters around the standard set. This allows for significant savings in limited quantum hardware resources, circumventing the need to train the reservoir. In addition, the irrelevance of fine-tuning naturally makes the QRC robust against hardware miscalibration noise. For decoding, all single-qubit, [symbol] zᵢ(tₖ) [symbol] , and two-qubit observables, [symbol] zᵢ(tₖ)zⱼ(tₖ) [symbol] are measured. While two-qubit observables are essential for good QRC performance, including three-body or higher observables doesn't lead to additional gains, although this might be the consequence of the limited encoding sizes simulated.

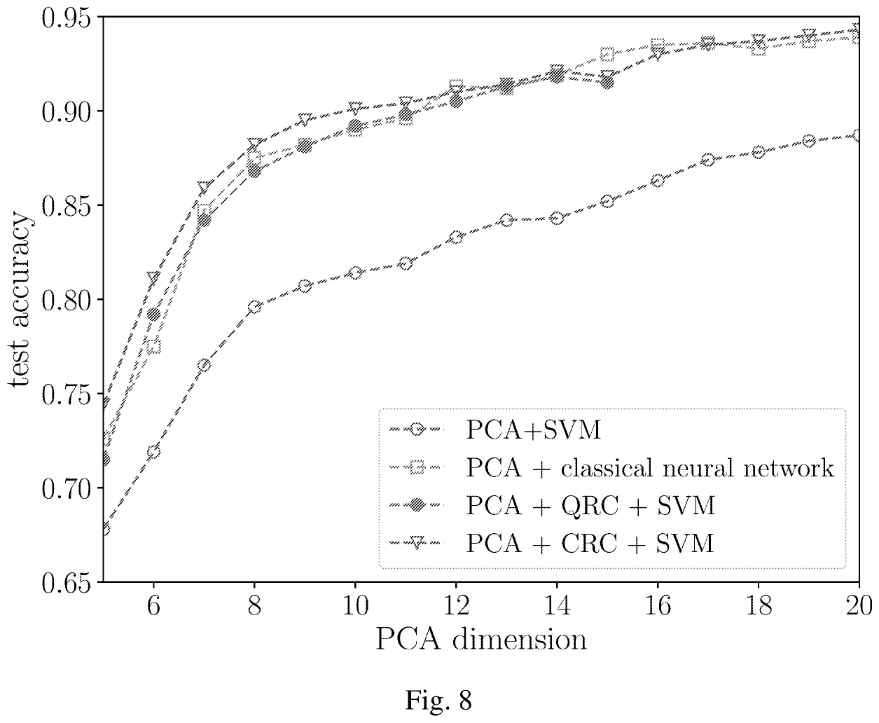

Referring to FIG. 8, the performance of QRC on the MNIST dataset with increasing PCA dimensions as compared to a linear classifier, 4-layer neural network, and classical spin reservoir (CRC). The QRC, CRC, and 4-layer neural network all effectively maximize the classification performance on the limited PCA dimension.

Increasing the number of qubits, and thus accessible encoding dimension for local detuning encoding, one can increase the PCA downsampling dimension, leading to the performance increase on the MNIST dataset, as shown in FIG. 8. Simulated QRC significantly outperforms linear classifier (linear SVM) applied to the equivalent PCA data, while it matches the performance of 4-layer feed-forward neural network with up to 40,000 training parameters. However, all indications are that PCA downsampled MNIST dataset shows a performance limit that all of the tested non-linear methods are able to reach, including QRC. Classical simulation only allows for efficient QRC performance estimates for less than 20 qubits: however, hardware can efficiently encode much higher PCA dimensions, which might allow for better differentiation between the performance of different machine learning models.

In additional embodiments, position encoding is employed. In particular, an encoding is provided by neutral atom quantum simulators, encoding into atomic positions. More specifically, the data feature vector, u, normalized to [0,1] range for each component, is encoded into the strengths of nearest neighbor interactions in a linear chain as:

$${V}_{i , i + 1} = \frac{C}{{d}^{6}} ( 1 + λ {u}_{i} ) \qquad Equation 13$$

where d is the reference interatomic distance when the data feature component is zero and λ is the encoding scale. In this way, N PCA components are encoded into interaction strengths between N+1 qubits. As Rydberg interaction is of the form nᵢnⱼ, such position encoding effectively induces local detuning equivalent on the neighboring qubits, as is evident by transforming to Z operators with

$$Z = n - \frac{1}{2} ,$$

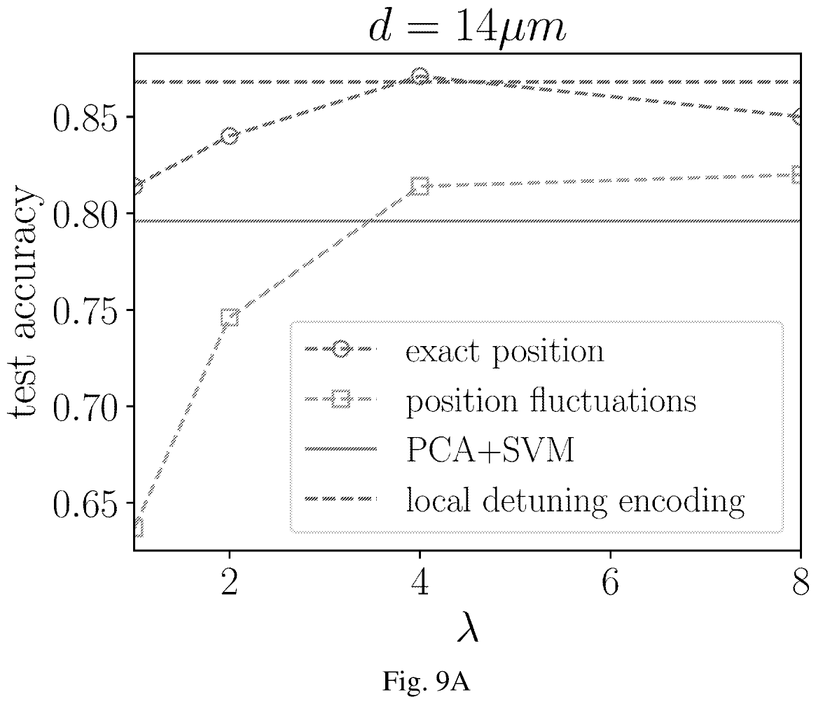

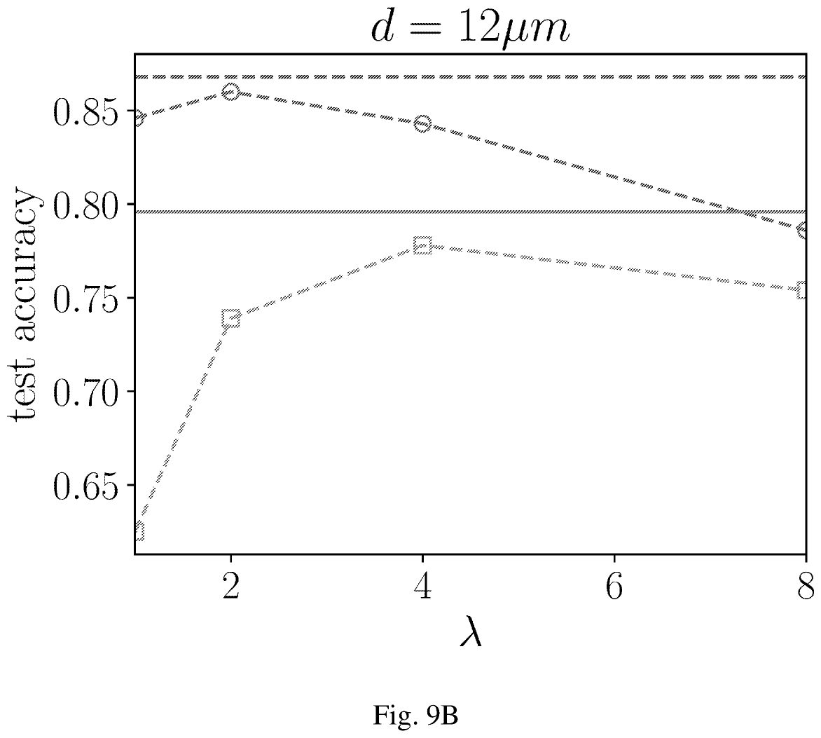

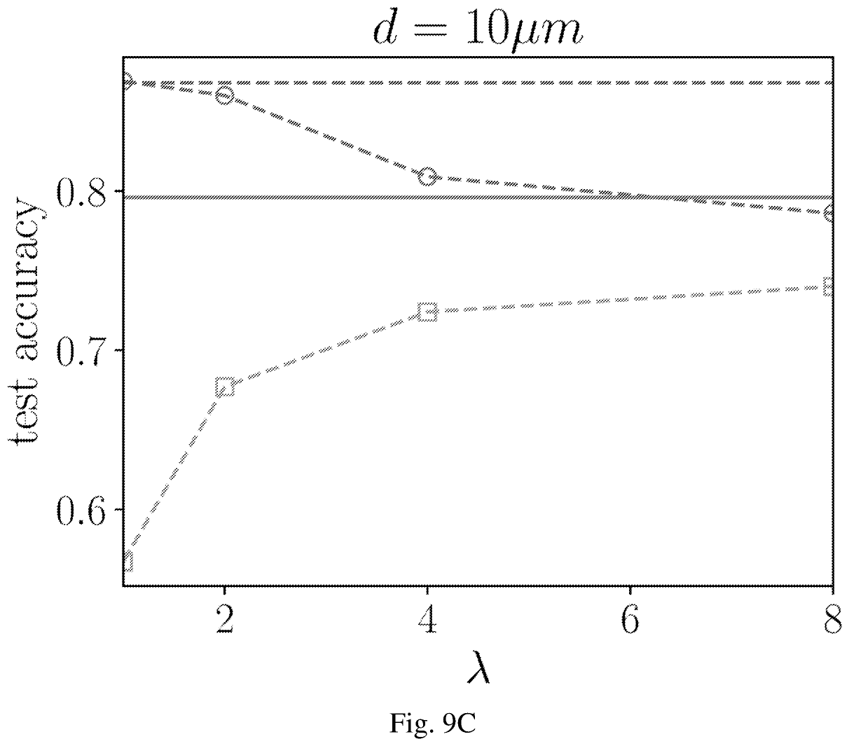

as well as encoding dependent two-qubit interaction. For this reason, the position encoding is expected to perform equivalently to local detuning encoding in an ideal setting in the same hyperparameter range. This is observed in simulations, as shown in FIGS. 9A-9C, where the standard parameters are used for Rabi frequency and global detuning, while reference atomic distance and scale A are changed. For different atomic distances, optimal scale A, where performance equivalent to local detuning encoding is reached, is such that the average atomic distance with encoded data is around 10 μm. As the reference distance increases, the optimal encoding scale moves to higher values, with the optimum itself being insensitive to the fine-tuning of the encoding scale.

Referring to FIGS. 9A-C, graphs are provided illustrating the performance of QRC on the MNIST dataset (8 PCA components) with position encoding, as a function of encoding scale (λ) for different initial interatomic distances. While position encoding with perfect position fidelity matches local detuning encoding for optimally chosen encoding scale, position fluctuations strongly degrade the performance.

A potential disadvantage of the position encoding on the neutral atom hardware is the sensitivity to the exact atomic positions. In exemplary hardware, atomic positions are uncertain on the scale of 0.1 μm, due to the thermal motion of the atoms in traps. As a consequence, this uncertainty is transferred directly to the data in the position encoding approach, thus degrading QRC performance. Atom position uncertainty is simulated by adding an independent Gaussian noise with 0.1 μm standard deviation to each atomic position. A new noise sample is drawn for each image in the dataset. This approach gives a lower estimate of the QRC position encoding performance, as in the hardware experiment, a new sample of position noise would be realized for each experimental measurement, and thus a part of the noise can be expected to average out through experimental repetitions for a given image. These simulations, however, show a drastic decrease in performance compared to the case without position fluctuations. This is somewhat ameliorated with increasing encoding scale, which increases the effective signal-to-noise ratio of the encoding. Encoding scale increase, in turn, requires increasing reference interatomic distance.

In order to compare the performance of QRC to related classical machine learning methods and explore the role of quantum entanglement, classical reservoir computing (CRC) is simulated with the classical spin Hamiltonian corresponding to the Rydberg Hamiltonian. Such a classical spin Hamiltonian can be obtained by promoting the

$$S = \frac{1}{2}$$

of a qubit to →∞, with qubits becoming classical vectors. The Rydberg Hamiltonian then describes the precession of classical spins, according to:

$$\frac{d {\vec{S}}_{ι}}{dt} = \frac{\partial H}{\partial {\vec{S}}_{ι}} \times {\vec{S}}_{ι}$$

where the effective magnetic field for the precession of spin i, given by:

$$\vec{{B}_{ι}} = \frac{\partial H}{\partial \vec{{S}_{ι}}} = \frac{Ω}{2} \hat{x} + [ - \frac{{Δ}_{i}}{2} + \frac{1}{4} {\sum }_{j \neq i} {V}_{i j} ( 1 + {S}_{j}^{( z )} ) ] \hat{z}$$

depends on the values of Rabi frequency, total detuning at the site (Δᵢ), and intersite interactions with other spins. While the states of precessing classical spins are correlated, they show no quantum entanglement.

The performance of the CRC on the standard parameter set is shown in FIGS. 8 and 4 as a function of increasing PCA dimension. In the PCA dimension range explored, CRC matches the QRC and 4-layer neural network performance, which is ascribed to all methods reaching the PCA downsampling dictated performance limits. Comparing CRC to QRC on the sizes accessible only by hardware is expected to give a more relevant performance comparison. As CRC is classically easy to simulate, it can also serve as a rough QRC performance lower bound (assuming an ideal quantum machine) for qubit numbers that are inaccessible to classical simulations.

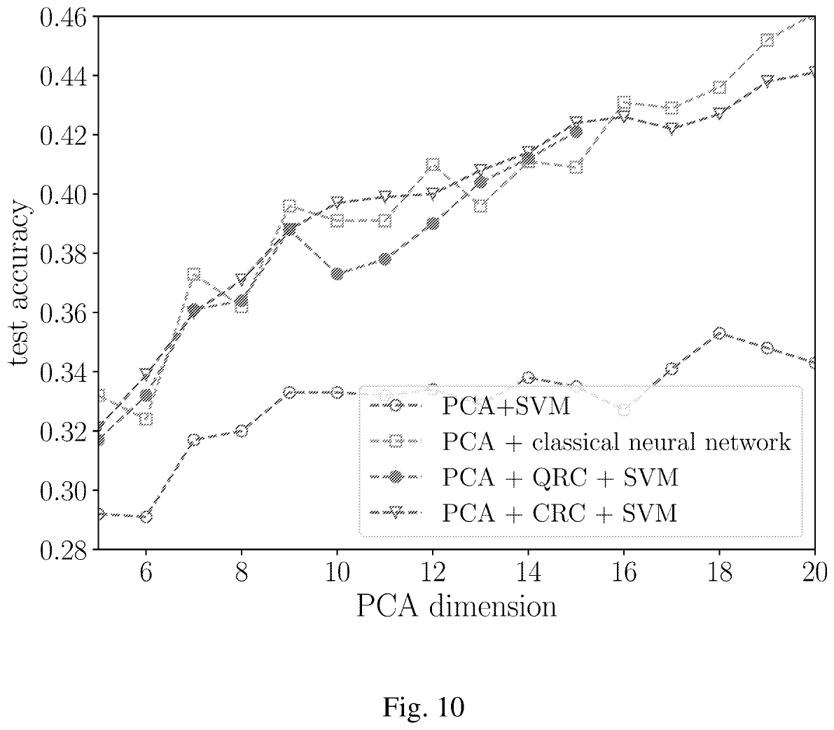

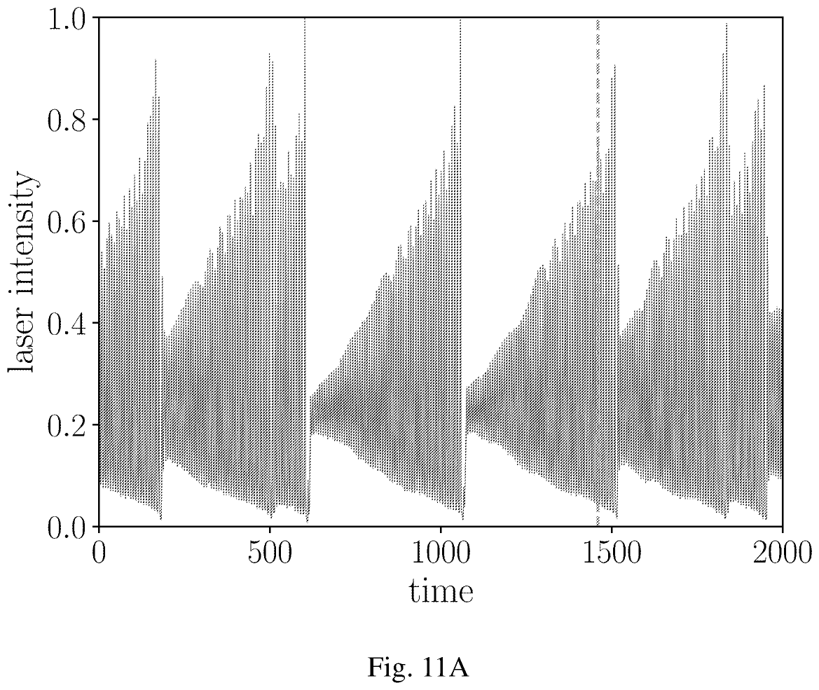

The following explores the QRC performance on a more complex image classification task, the CIFAR-10 task, introduced in FIG. 4. While still being a 10-class dataset, akin to MNIST, the classes in the CIFAR-10 are significantly more diverse; for example, a class of dogs contains different breeds of dogs. As a result, CIFAR-10 is known to be a harder machine learning task. The results, presented in FIG. 10, corroborate this, with classification accuracies of around 42% at 15 PCA components. The QRC, however, is still able to max out the performance on the limited PCA, together with other non-linear models (CRC, 4-layer neural network), and to significantly outperform a linear classifier. As CIFAR-10 requires many PCA components for successful classification, it might be a natural dataset to explore the QRC performance in quantum hardware.

Referring to FIG. 10, a graph is provided illustrating the performance of QRC on the CIFAR-10 dataset with increasing PCA dimensions as compared to a linear classifier, 4-layer neural network, and classical spin reservoir. Similarly to the MNIST dataset, all non-linear methods maximize the available performance on the limited PCA dimension, although the overall performance level is lower, reflecting the hardness of the task.

In various embodiments, QRC is used for regression machine learning tasks, such as time series prediction, showing the versatility of the QRC algorithm. Simulated results are provided for a benchmark task and the first runs on exemplary quantum hardware.

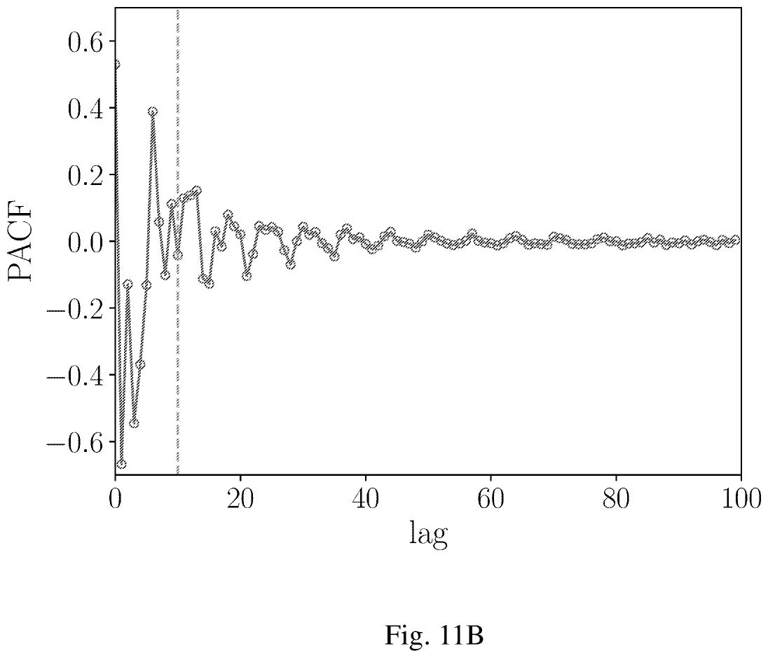

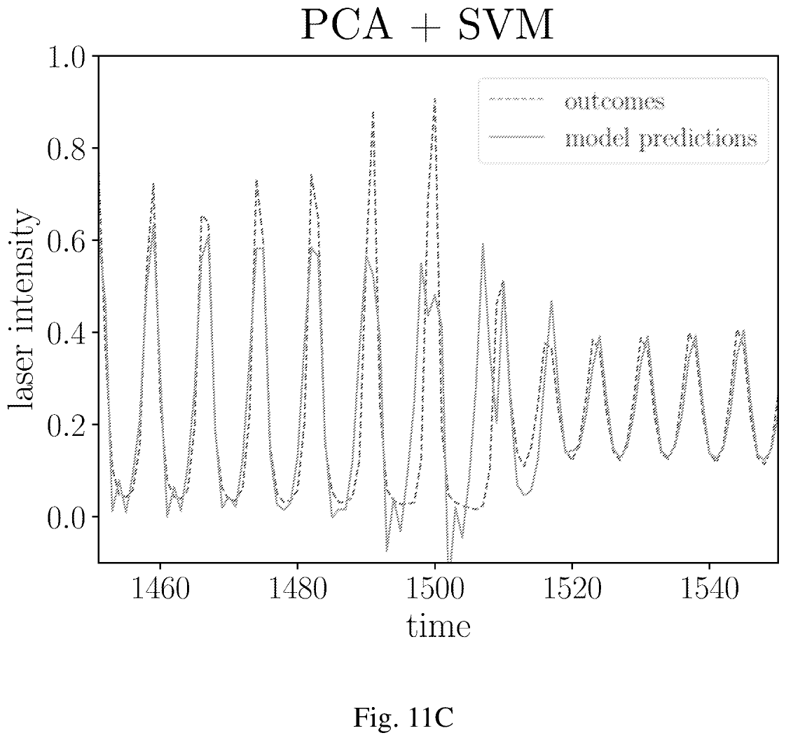

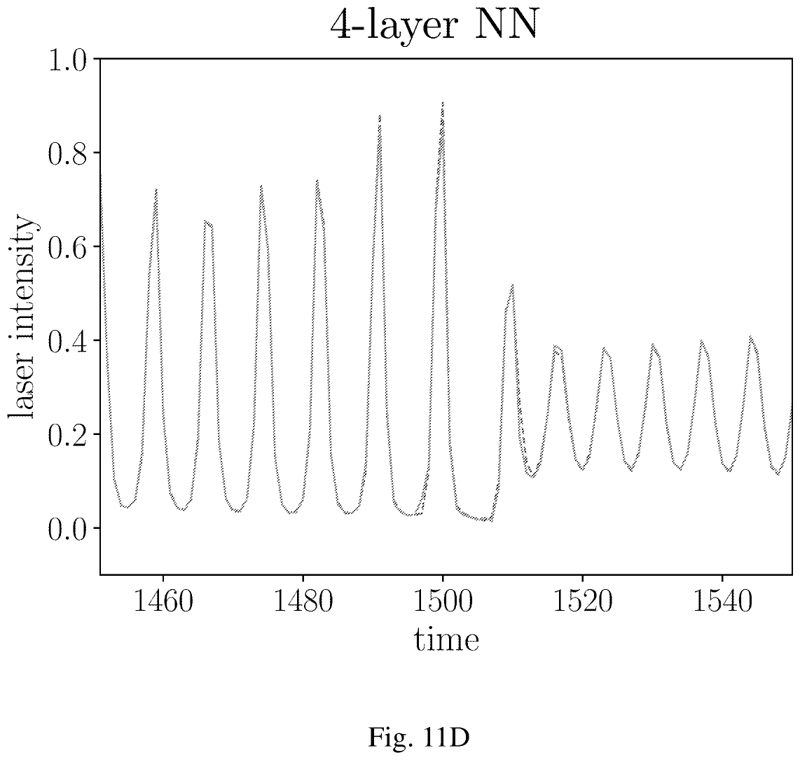

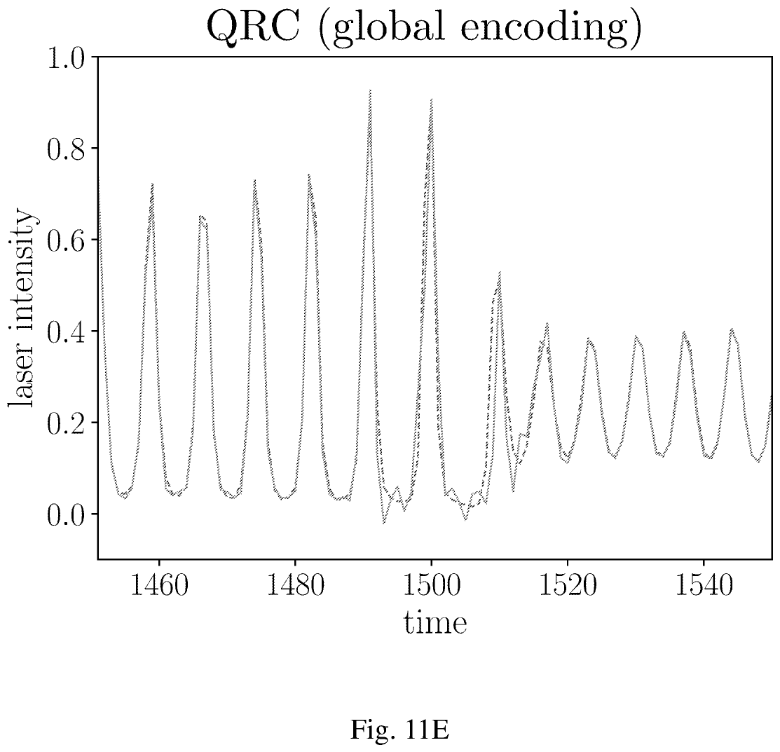

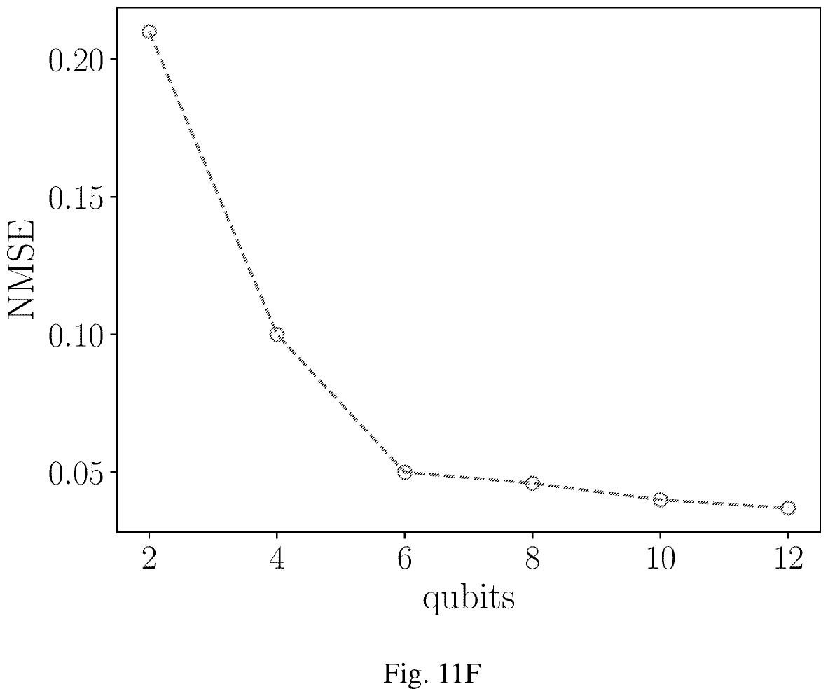

The Santa Fe laser time series provides an example of a time series prediction task, which captures the experimentally measured chaotic behavior of an infrared laser. It was used initially on a time series prediction challenge and ever since as a standard benchmark for time series prediction models. The task itself is a univariate time series with 2000 time points, as shown in FIG. 11A. To benchmark the algorithms provided herein, the prediction success is evaluated on the next step prediction and feed windows of 10 previous time series data points. This time window corresponds to the partial autocorrelation function (PACF) falling to 0.1 scale, as seen in FIG. 11B, denoting that the majority of the correlations in the time series should be captured by the window, although increasing the window size would further only increase the performance of tested models. The data are divided into a testing set of the first 1400 time windows, and the models' performance is evaluated on the remaining 600 time windows. This ensures that the training set includes several large regime switches in laser intensity, traditionally hard for modeling the dataset, and at least one such switch in the testing set. The embeddings are fed into a linear regression layer that is trained according to the normalized mean square error between predicted outcomes across the training/testing set (ŷₖ) and the actual outcomes (yₖ, with mean \tilde{y}), given by:

$$N M S E = \frac{{\sum }_{k} {( {\hat{y}}_{k} - {y}_{k} )}^{2}}{{\sum }_{k} {( {y}_{k} - \overline{y} )}^{2}}$$

normalized such that the value of 1 corresponds to the model that predicts the mean of the time series.

TABLE 1

| Model | NMSE |
|---|---|
| naive (tₙ₊₁ = tₙ) | 0.96 |
| PCA + SVM | 0.21 |
| 4-layer NN | 0.003 |
| QRC (local detuning encoding) | 0.006 |
| QRC (global detuning encoding) | 0.04 |
| QRC (global detuning encoding, irregular positions) | 0.025 |

Table 1 lists the performance of various QRC encodings and different classical models on the SFlas task (lower NMSE is better). All global detuning encoding performance is reported on 10 qubit linear chains.

To encode the time series window features into the QRC pipeline, two approaches are provided. The first of these is the local detuning encoding, in the same fashion as discussed above for image classification, but with the system limited to 10 qubits, corresponding to the input feature size. Given the time-dependent nature of the data, the time series features are encoded into a global detuning time-dependent pulse, Δ(t). The 4 μs pulse is divided into ten intervals and the rescaled value of the input laser intensity is encoded as the starting value for global detuning in each interval. These values are then connected with a piece-wise linear pulse, motivated by the hardware capabilities. In the last interval, the value of global detuning is kept constant and equal to the last time-point of the window. The quantum embedding data is then collected at the end of each time interval. Data encoding frequency here is comparable to half of the Rabi period (with standard Ω(t)=1 rad/μs), which is the physical limit beyond which additional encoded data cannot be effectively processed by quantum evolution. The longer windows can be encoded with larger Rabi frequencies, with all other scales in the Hamiltonian increased correspondingly and/or longer evolution times. In contrast to local detuning, global detuning encoding has the system size as the tunable parameter. For both the local detuning encoding and global detuning encoding, the standard parameter choices in terms of the atom geometry, distance, Rabi frequency, and the size scale of the detuning scale give a near-optimal performance. This reinforces the robustness of the parameter choice, as the same physical set performs well for different tasks and even different encodings.

Referring to FIGS. 11A-F, graphs are provided illustrating the Santa Fe laser prediction task. FIG. 11A shows the Santa Fe laser time series (SFlas task) with a split between train and test denoted by a dashed vertical line. FIG. 11B shows a partial autocorrelation function of the SFlas series, with the chosen lag window (10) denoted by a vertical dashed line. FIGS. 11C-E show a comparison of the next step predictions (solid) and true laser outcomes (dashed) for (FIG. 11C) linear (FIG. 11D) 4-layer neural network (FIG. 11E) global detuning encoded QRC) on a portion of the dataset containing a switch between laser regimes. FIG. 11F shows global detuning encoded QRC performance as a function of qubit number.

The results of QRC time series prediction as well as a comparison to several classical methods are shown in Table 1, while typical performances of different methods on a piece of the test set containing a laser regime switch is shown in FIGS. 11C-E. As a performance benchmark, the loss of the naive model is evaluated, which predicts the next time series point to be equal to the previous point, the linear model, as well as the 4-layer neural network. The local detuning encoded QRC achieves loss comparable to a 4-layer neural network and two orders of magnitude better than linear regression, likely maximizing the performance given the size of the input window. The differences between the performance of different models are the most drastic at the switch between high- and low-amplitude laser regimes, where non-linearities captured by the classical neural network and QRC are essential.

Global detuning encoded QRC performance on 10 qubits is significantly above the linear regression performance, albeit behind local detuning encoded QRC and the 4-layer neural network. This likely points to a lower encoding capacity of the global detuning encoding method. Empirically, the performance of the global detuning encoding improves somewhat if atom positions in a linear chain are perturbed from the perfect periodic arrangement. This is explained by circumventing approximate translational symmetry existing in the system at initial times when starting from all qubits in the ground state, where it takes some time for the information about the presence of the boundaries to spread. By perturbing the atom positions by a Gaussian process with 1 μm standard deviation, the translational symmetry is broken strongly, leading to more expressive embeddings for the early stages of the evolution.

The scaling of global detuning encoded QRC as a function of qubit number is shown in FIG. 11F. The performance increases significantly with increasing system size.

In an exemplary embodiment, the SFlas time series task is implemented with global detuning encoding and irregular atom positions into QuEra's analog Hamiltonian simulator—Aquila. Compared to the above simulation, on and off ramps of 50 ns each are present for Rabi and global detuning pulses, which doesn't affect the performance in simulation. The 10-qubit system is used, while 60 samples per data point were drawn. The 6 chains are being evolved in parallel across 10 repetitions, each 15 μm apart, making interchain interactions negligible. The part of the dataset processed by this implementation includes timepoints for 1000 to 1400 which were taken as the training set and 1401 to 1473 taken as the test set. The training set thus contains one laser regime change, while the testing set is wholly within one regime. This makes the effective set easier to learn and the corresponding performance benchmarks are 0.1 NMSE for linear regression, 10⁻³ for classical neural network, and 2×10⁻³ for globally encoded QRC in a perfect simulation with exact expectation values.

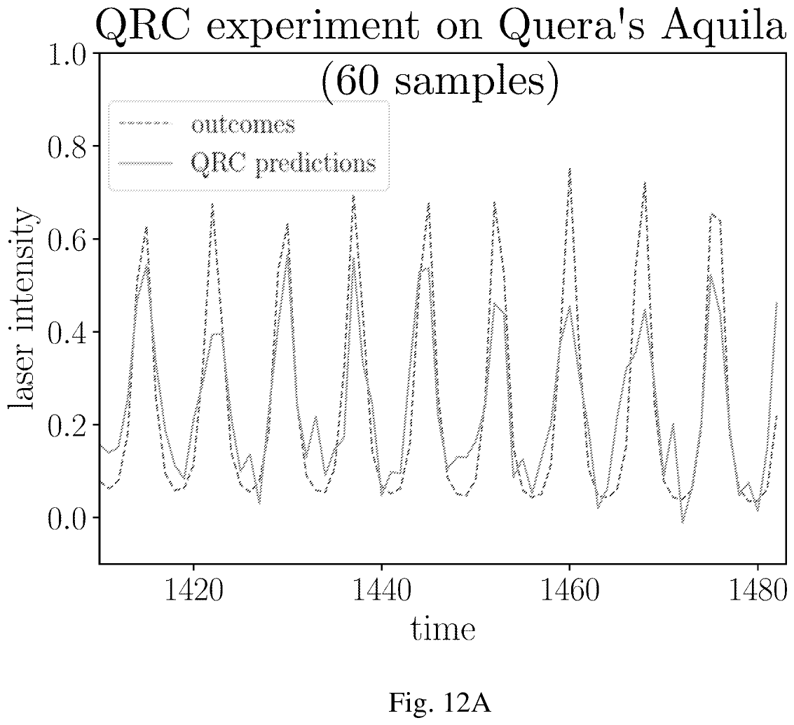

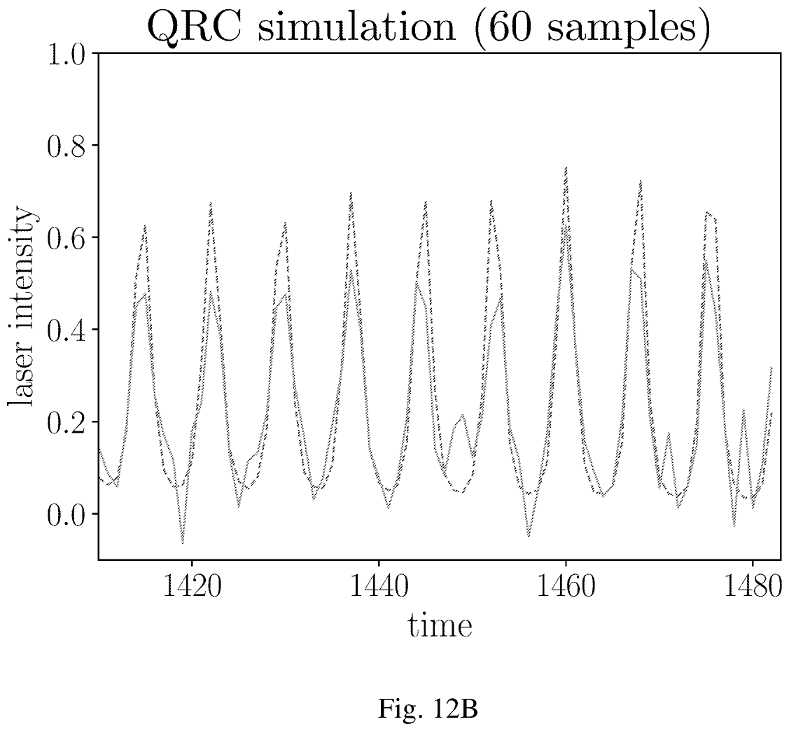

FIG. 12A-B are graphs illustrating experimental and simulated predictions (solid) on the part of the test set with 60 samples drawn for each QRC embedding.

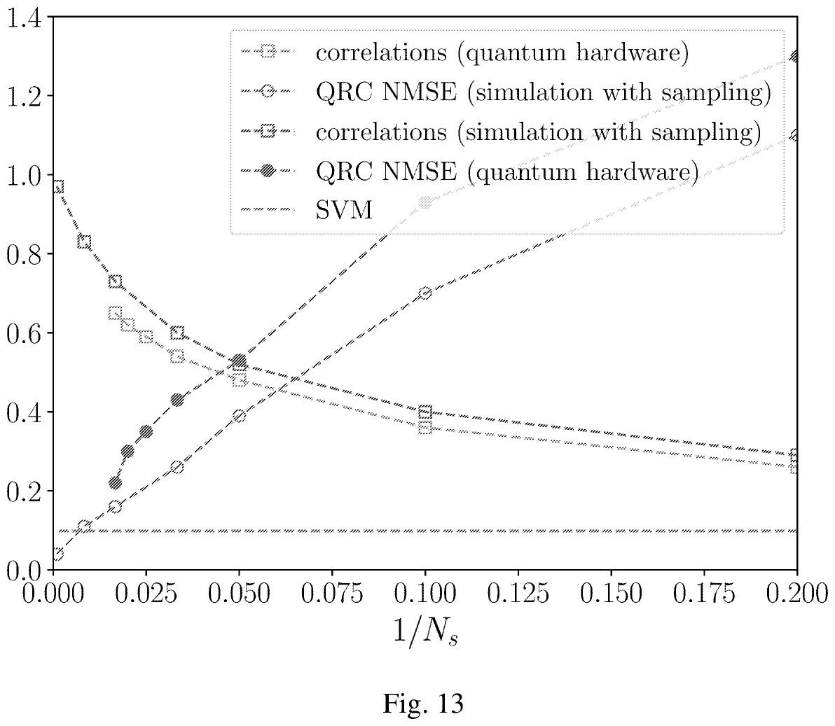

The QRC predictions (solid) from hardware embeddings are presented on the test set in FIGS. 12A-B, together with the result from perfect simulation (dashed) limited to 60 samples drawn per data point. The NMSE of hardware run QRC is 0.21, with training performed with heavy L¹ regularization to prevent overfitting. While this is below the linear classifier, it is close to the performance expected in simulation with 60 samples per data point (NMSE 0.19). Thus, the main performance limitation stems from the finite precision of embeddings generated with finite sampling. To explore the sampling requirements of the hardware and the algorithm, QRC performance scaling is provided in simulations with sampling and on hardware with limited number of shots (up to 60) in FIG. 13. The experimental results show clear performance scaling with increased sample count and are expected to beat SVM performance in the range of 100-1000 experimental samples. Even more remarkably, simulations with sampling show the same scaling with the shot count. Good quality of hardware embeddings is also shown in statistical correlations between perfect exactly evaluated embeddings and hardware-generated embeddings that are within 0.1 of simulations with sampling.

Referring to FIG. 13, a graph of experimental and simulated performance for the SFlas task is shown as a function of the number of samples drawn per data point.

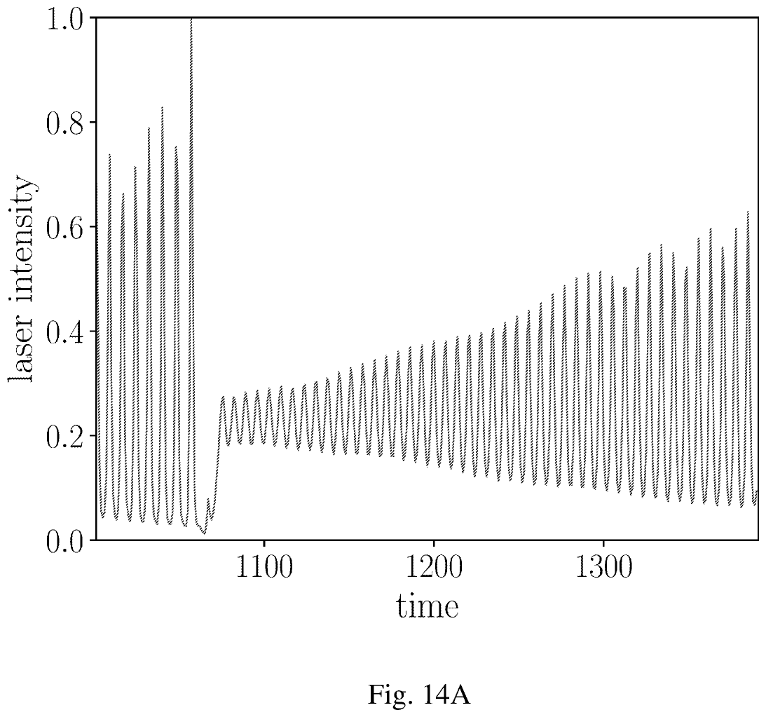

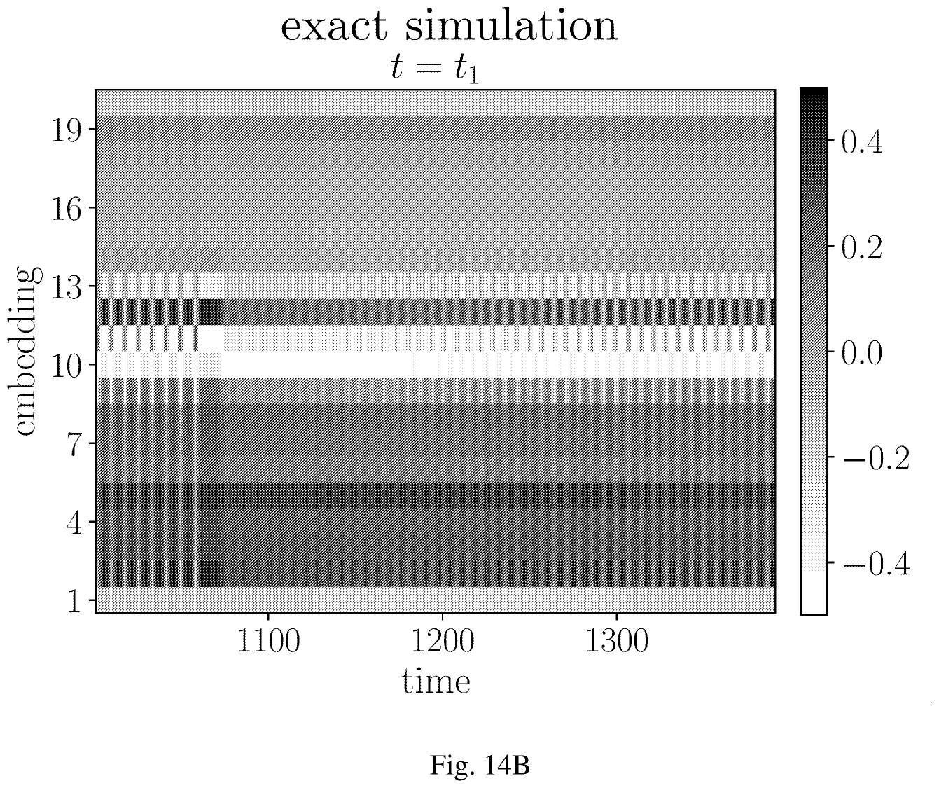

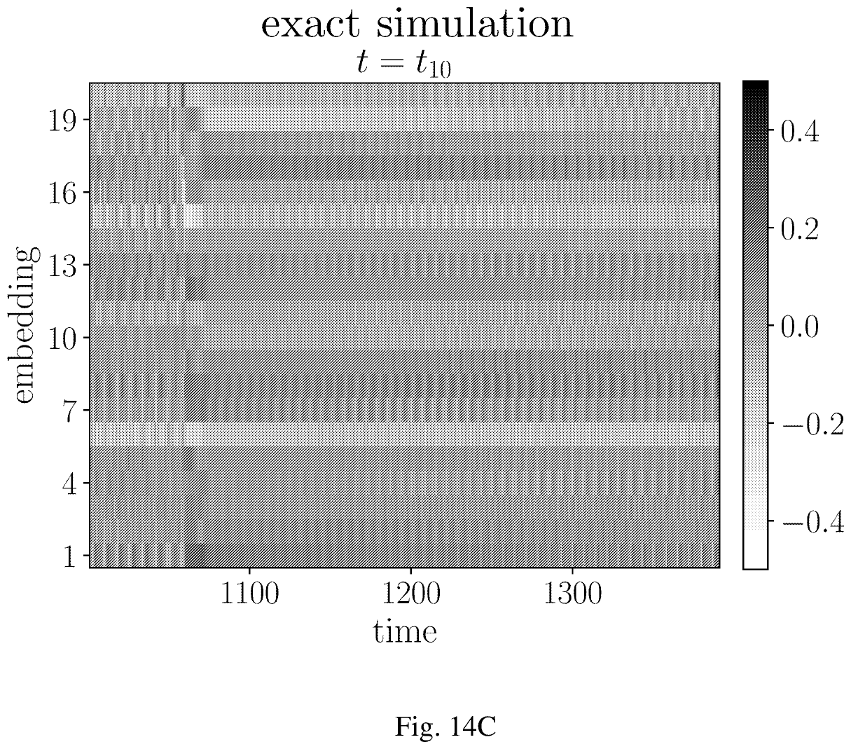

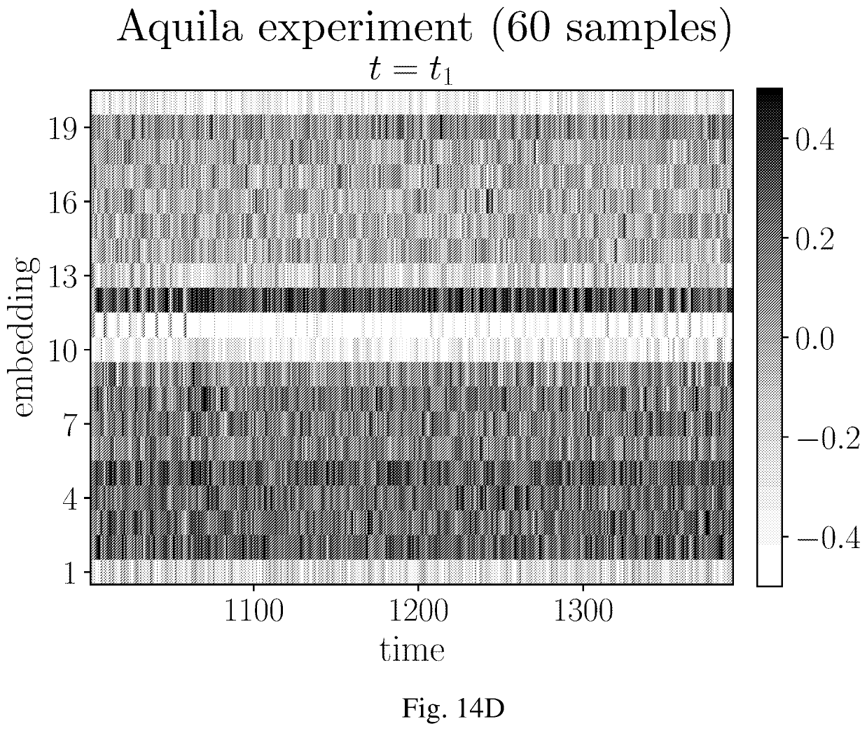

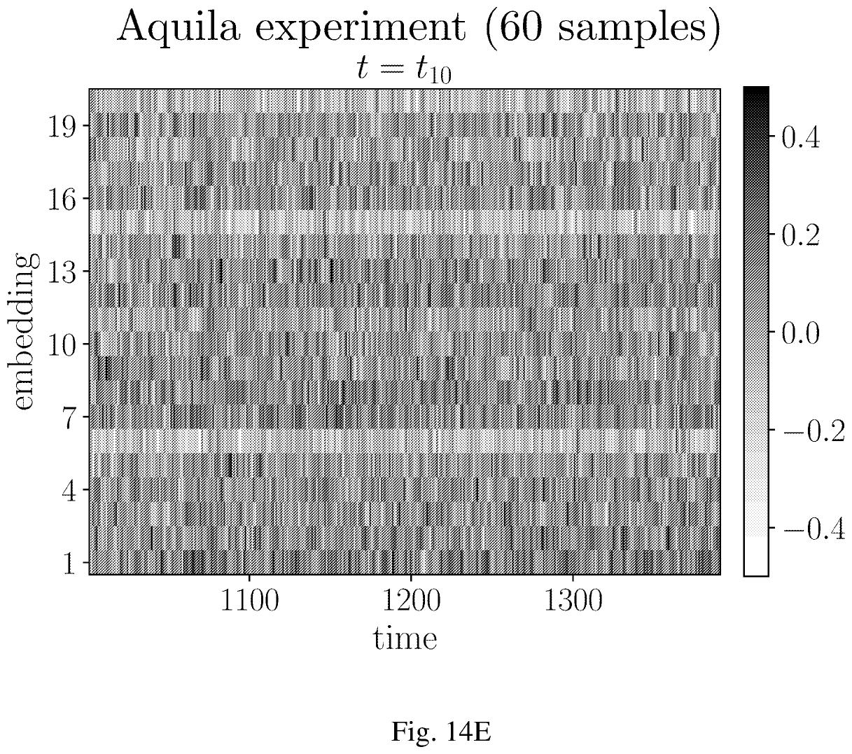

Referring to FIGS. 14A-E, graphs are provided illustrating QRC embeddings for the SFlas series (FIG. 14A) as obtained by exact simulation (FIGS. 14B-C), and Aquila experiment on 60 samples (FIGS. 14D-E).

In FIGS. 14B-E, a part of QRC embeddings on the partial SFlas training set is shown, both in exact simulation (FIGS. 14B-C) and in hardware (FIGS. 14D-E). More specifically, 10 [symbol] zᵢ [symbol] expectation values, as well as the first ten correlators [symbol] zᵢzⱼ [symbol] (ordered such that j>i, j≠i), are shown in the first and last measurement time points. In the exact simulation, each of the embeddings clearly relates to the training set; however, different embeddings provide a new (transformed) look at the data. Through QRC embedding, SVM can then process different non-linear functions of the data, improving the performance. Compared to the first time point, contrast in the last time point embeddings is significantly reduced due to a partially thermalizing quantum state: however, the transformed data features are clearly observed. This is potentially a reason for the lower performance of global detuning encoded QRC, compared to local detuning encoding, where the most important time window (last) is encoded near the end of the quench. Potential improvements might be possible if the window is reversed for QRC encoding. In contrast, the effect of sample noise is drastic in hardware. While the main features of the training data can still be inferred, as well as the main embedding features seen in simulation, the loss of precision in embeddings is critical as it directly affects the data, unlike the robust Hamiltonian parameter encoding itself. However, sampling adds only a polynomial overhead to the algorithm in terms of precision needed for a set accuracy/loss and doesn't affect its robustness and scalable construction otherwise.

### Formation of Array of Particles Using Optical Tweezers

Optical trapping of neutral atoms is a powerful technique for isolating atoms in vacuum. Atoms are polarizable, and the oscillating electric field of a light beam induces an oscillating electric dipole moment in the atom. The associated energy shift in an atom from the induced dipole, averaged over a light oscillation period, is called the AC Stark shift. Based on the AC Stark shift induced by light that is detuned (i.e., offset in wavelength) from atomic resonance transitions, atoms are trapped at local intensity maxima (for red detuned, that is, longer wavelength trap light), because the atoms are attracted to light below the resonance frequency. The AC Stark shift is proportional to the intensity of the light. Thus, the shape of the intensity field is the shape of an associated atom trap. Optical tweezers utilize this principle by focusing a laser to a micron-scale waist, where individual atoms are trapped at the focus. Two-dimensional (2D) arrays of optical tweezers are generated by, for example, illuminating a spatial light modulator (SLM), which imprints a computer-generated hologram on the wavefront of the laser field. The 2D array of optical tweezers is overlapped with a cloud of laser-cooled atoms in a magneto-optical trap (MOT). The tightly focused optical tweezers operate in a “collisional blockade” regime, in which single atoms are loaded from the MOT, while pairs of atoms are ejected due to light-assisted collisions, ensuring that the tweezers are loaded with at most single atoms, but the loading is probabilistic, such that the trap is loaded with a single atom with a probability of about 50-60%.

To prepare deterministic atom arrays, a real-time feedback procedure identifies the randomly loaded atoms and rearranges them into pre-programmed geometries. Atom rearrangement requires moving atoms in tweezers which can be smoothly steered to minimize heating, by using, for example, acousto-optic deflectors (AODs) to deflect a laser beam by a tunable angle which is controlled by the frequency of an acoustic waveform applied to the AOD crystal. Dynamic tuning of the acoustic frequency translates into smooth motion of an optical tweezer. A multi-frequency acoustic wave creates an array of laser deflections, which, after focusing through a microscope objective, forms an array of optical tweezers with tunable position and amplitude that are both controlled by the acoustic waveform. Atoms are rearranged by using an additional set of dynamically moving tweezers that are overlaid on top of the SLM tweezer array.

### Exemplary Hardware

Optical tweezer arrays constitute a powerful and flexible way to construct large scale systems composed of individual particles. Each optical tweezer traps a single particle, including, but not limited to, individual neutral atoms and molecules for applications in quantum technology. Loading individual particles into such tweezer arrays is a stochastic process, where each tweezer in the system is filled with a single particle with a finite probability p<1, for example p˜0.5 in the case of many neutral atom tweezer implementations. To compensate for this random loading, real-time feedback may be obtained by measuring which tweezers are loaded and then sorting the loaded particles into a programmable geometry. This may be performed by moving one particle at a time, or in parallel.

Parallel sorting may be achieved by using two acousto-optic deflectors (AODs) to generate multiple tweezers that can pick up particles from an existing particle-trapping structure, move them simultaneously, and release them somewhere else. This can include moving particles around within a single trapping structure (e.g., tweezer array) or transporting and sorting particles from one trapping system to another (e.g., between one tweezer array and another type of optical/magnetic trap). This sorting is flexible and allows programmed positioning of each particle. Each movable trap is formed by the AODs and its position is dynamically controlled by the frequency components of the radiofrequency (RF) drive field for the AODs. Since the RF drive of the AODs can be controlled in real time and can include any combination of frequency components, it is possible to generate any grid of traps (such as a line of arbitrarily positioned traps), move the rows or columns of the grid, and add or remove rows and columns of the grid, by changing the number, magnitude, and distribution of the frequency components in the RF drive fields of the AODs.

In an exemplary embodiment, an optical tweezer array is created using a liquid crystal on silicon spatial light modulator (SLM), which can programmatically create flexible arrangements of tweezers. These tweezers are fixed in space for a given experimental sequence and loaded stochastically with individual atoms, such that each tweezer is loaded with probability p˜0.5. A fluorescence image of the loaded atoms is taken, to identify in real-time which tweezers are loaded and which are empty.

After detecting which tweezers are loaded, movable tweezers overlapping the optical tweezer array can dynamically reposition atoms from their starting locations to fill a target arrangement of traps with near-unity filling. The movable tweezers are created with a pair of crossed AODs. These AODs can be used to create a single moveable trap which moves one atom at a time to fill the target arrangement or to move many atoms in parallel.

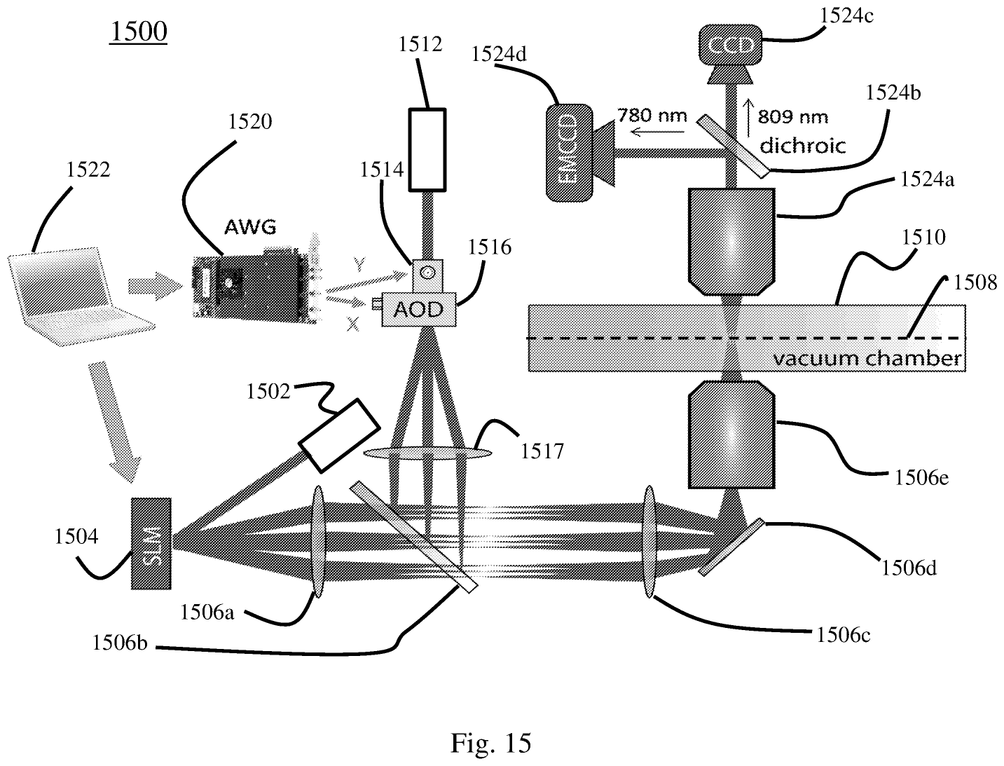

Referring to FIG. 15, a schematic view is provided of an apparatus 1500 for quantum computation according to embodiments of the present disclosure. As shown in FIG. 15, using a beam generated by a light source 1502 (for example, a coherent light source, in some example embodiments—a monochromatic light source), SLM 1504 forms an array of trapping beams (i.e., a tweezer array) which is imaged onto trapping plane 1508 in vacuum chamber 1510 by an optical train that, in the example embodiment shown in FIG. 15, comprises elements 1506a, 1506c, 1506d, and a high numerical aperture (NA) objective 1506e. Other suitable optical trains can be employed, as would be easily recognized by a person of ordinary skill in the art. Using a beam generated by light source 1512 (for example, a coherent light source; in some example embodiments—a monochromatic light source), a pair of AODs 1514 and 1516, having non-parallel directions of acoustic wave propagation (for example, orthogonal directions) creates dynamically movable sorting beams. By using the optical train, such as the one depicted in FIG. 15 (elements 1517, 1506b, 1506c, 1506d, and 1506e), the sorting beams are overlapped with the trapping beams. It is understood that other optical train can be used to achieve the same result. For example, source 1502 and 1512 can be a single source, and the trapping beam and the sorting beam are generated by a beam splitter.

The dynamic movement of the steering beams is accomplished by employing two non-parallel AODs 1514, 1516, arranged in series. In the example embodiment depicted in FIG. 15, one AOD defines the direction of “rows” (“horizontal”—the ‘X’ AOD) and the other AOD defines the direction of “columns” (“vertical”—the ‘Y’ AOD). Each AOD is driven with an arbitrary RF waveform from an arbitrary waveform generator 1520, which is generated in real-time by a computer 1522 which processes the feedback routine after analyzing the image of where atoms are loaded. If each AOD is driven with a single frequency component, then a single steering beam (“AOD trap”) is created in the same plane 1508 as the SLM trap array. The frequency of the X AOD drive determines the horizontal position of the AOD trap, and the frequency of the Y AOD drive determines the vertical position: in this way, a single AOD trap can be steered to overlap with any SLM trap.

In FIG. 15, laser 1502 projects a beam of light onto SLM 1504. SLM 1504 can be controlled by computer 1522 in order to generate a pattern of beams (“trapping beams” or “tweezer array”). The pattern of beams is focused by lens 1506a, passes through mirror 1506b, and is collimates by lens 1506c on mirror 1506d. The reflected light passes through objective 1506e to focus an optical tweezer array in vacuum chamber 1510 on trapping plane 1508. The laser light of the optical tweezer array continues through objective 1524a, and passes through dichroic mirror 1524b to be detected by charge-coupled device (CCD) camera 1524c.

Vacuum chamber 1510 may be illuminated by an additional light source (not pictured). Fluorescence from atoms trapped on the trapping plane also passes through objective 1524a, but is reflected by dichroic mirror 1524b to electron-multiplying CCD (EMCCD) camera 1524d.

In this example, laser 1512 directs a beam of light to AODs 1514, 1516. AODs 1514, 1516 are driven by arbitrary wave generator (AWG) 1520, which is in turn controlled by computer 1522. Crossed AODs 1514, 1516 emit one or more beams as set forth above, which are directed to focusing lens 1517. The beams then enter the same optical train 1506b . . . 1506e as described above with regard to the optical tweezer array, focusing on trapping plane 1508.

It will be appreciated that alternative optical trains may be employed to produce an optical tweezer array suitable for use as set out herein.

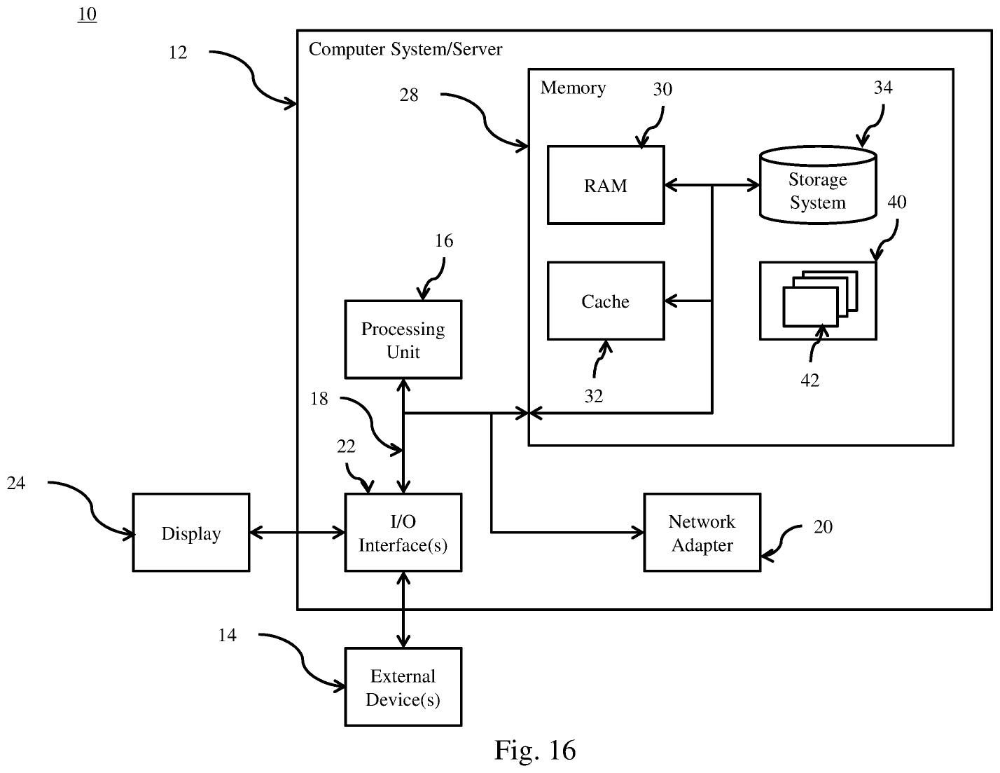

Referring now to FIG. 16, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 16, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining a first feature vector from input data, the first feature vector comprising a plurality of values;
configuring a plurality of qubits in an initial configuration according to the first feature vector, wherein a detuning, Rabi frequency, phase, and/or position of each of the plurality of qubits is determined by a respective one of the values of the first feature vector;
evolving the plurality of qubits for a first time;
measuring the plurality of qubits to obtain first measurements after the first time;
returning the plurality of qubits to the initial configuration;
evolving the plurality of qubits for a second time different from the first time;
measuring the plurality of qubits to obtain second measurements after the second time;
determining a second feature vector from the first and second measurements;
providing the second feature vector to a decoder and obtaining therefrom a characteristic of the input data.

2. The method of claim 1, wherein determining the first feature vector comprises providing the input data to an autoencoder and receiving therefrom the first feature vector.

3. The method of claim 1, wherein determining the first feature vector comprises performing a principal component analysis.

4. The method of claim 1, wherein the plurality of qubits are trapped ions.

5. The method of claim 1, wherein the plurality of qubits are superconducting qubits.

6. The method of claim 1, wherein the plurality of qubits are neutral atoms.

7. The method of claim 6, wherein each of the plurality of qubits is disposed in a corresponding optical trap.

8. The method of claim 7, wherein the plurality of qubits is disposed along a line.

9. The method of claim 7, wherein each of the plurality of qubits is disposed at the vertices of a lattice.

10. The method of claim 8, wherein the lattice is a square lattice.

11. The method of claim 9, wherein the each of the plurality of qubits is disposed within a blockade radius of its nearest neighbors in the lattice.

12. The method of claim 1, wherein each of the plurality of qubits is configured to interact with at least another of the plurality of qubits during said evolution.

13. The method of claim 12, wherein each of the plurality of qubits is configured to interact with its nearest neighbors among the plurality of qubits during said evolution.

14. The method of claim 1, wherein configuring the plurality of qubits in the initial configuration comprises applying a time-independent local detuning to each of the plurality of qubits proportionate to its respective one of the values of the first feature vector.

15. The method of claim 1, wherein configuring the plurality of qubits in the initial configuration comprises applying one of a time-dependent global detuning, a time-dependent global Rabi frequency, or a time-dependent global phase to the plurality of qubits proportionate to its respective one of the values of the first feature vector.

16. The method of claim 1, wherein configuring the plurality of qubits in the initial configuration comprises applying a local Rabi frequency and phase to each of the plurality of qubits, each proportionate to its respective one of the values of the first feature vector.

17. The method of claim 1, wherein configuring the plurality of qubits in the initial configuration comprises displacing each qubit from a lattice by an amount proportionate to its respective one of the values of the first feature vector.

18. The method of claim 1, wherein the first and second measurements are single qubit Pauli observables of the plurality of qubits, and wherein the second feature vector comprises the first and second measurements.

19. The method of claim 18, wherein determining the second feature vector comprises computing one or more correlations of the first and second measurements, and wherein the second feature vector comprises the first and second measurements and the one or more correlations of the first and second measurements.

20. The method of claim 1, wherein the decoder comprises a classifier.

21. The method of claim 20, wherein the classifier comprises a linear classifier.

22. The method of claim 20, further comprising training the classifier based on the classification of the input data.

23. The method of claim 1, wherein the decoder comprises a classical machine learning model.

24. The method of claim 1, wherein the decoder comprises a classical neural network.

25. The method of claim 23, wherein the classical neural network comprises a linear regression layer.

26. The method of claim 24, further comprising training the linear regression layer based on the prediction of the input data.

27. The method of any one of claims 1-26, wherein the characteristic comprises a class label of the input data.

28. The method of any one of claims 1-26, wherein the characteristic comprises an outcome variable of the input data.

29. The method of any one of claims 1-26, wherein the input data comprise a time-series and wherein the characteristic comprises a predicted future value of the time-series.

30. A computing device, comprising:
a plurality of optical traps;
a plurality of neutral atoms, each of the plurality of neutral atoms disposed in a corresponding one of the plurality of optical traps;
at least one laser;
an imaging sensor; and
a computing node, the computing node configured to
determining a first feature vector from input data, the first feature vector comprising a plurality of values;
cause the at least one laser to configure the plurality of neutral atoms in an initial configuration according to the first feature vector, wherein a detuning, Rabi frequency, phase, and/or position of each of the plurality of neutral atoms is determined by a respective one of the values of the first feature vector;
measure the plurality of neutral atoms via the imaging sensor to obtain first measurements after a first time;
cause the at least one laser to return the plurality of neutral atoms to the initial configuration;
measure the plurality of neutral atoms to obtain second measurements after a second time;
determine a second feature vector from the first and second measurements;
provide the second feature vector to a decoder and obtaining therefrom a characteristic of the input data.

31. A computer program product comprising a computer readable storage medium having program instructions embodied therewith, the program instructions executable by a processor to cause the processor to perform a method comprising:
determining a first feature vector from input data, the first feature vector comprising a plurality of values;
cause the at least one laser to configure the plurality of neutral atoms in an initial configuration according to the first feature vector, wherein a detuning, Rabi frequency, phase, and/or position of each of the plurality of qubits is determined by a respective one of the values of the first feature vector;
measure the plurality of neutral atoms via the imaging sensor to obtain first measurements after a first time;
cause the at least one laser to return the plurality of neutral atoms to the initial configuration;
measure the plurality of neutral atoms to obtain second measurements after a second time;
determine a second feature vector from the first and second measurements;
provide the second feature vector to a decoder and obtaining therefrom a characteristic of the input data.
